(19) United States
(12) Patent Application Publication
(10) Pub. No.: US 2008/0180365 A1
(43) Pub. Date: Jul. 31, 2008

(54) DISPLAY DEVICE AND DRIVING METHOD FOR DISPLAY DEVICE

(75) Inventor: Tsuyoshi OZAKI, Fuchu-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO., LTD., Tokyo (JP)

(21) Appl. No.: 12/056,161

(22) Filed: Mar. 26, 2008

Related U.S. Application Data
(63) Continuation of application No. PCT/JP2006/319170, filed on Sep. 27, 2006.

(30) Foreign Application Priority Data
Sep. 27, 2005 (JP) 2005-279492

(51) Int. Cl. G09G 3/30

(52) U.S. Cl. 345/76

(57) ABSTRACT

A display driving device includes a gradation voltage generating section which generates gradation voltage corresponding to display data, a constant current circuit section which supplies a predetermined constant current to a display pixel, a voltage detecting section which detects a voltage of a data line at the time of supplying the constant current as a detected voltage, and a voltage adding section which adds and subtracts the gradation voltage, a reference voltage corresponding to the detected voltage and an intrinsic voltage determined based on a design parameter of a driving transistor provided to the display pixel (driving circuit) so as to generate a pixel data voltage Vpix (=Vref−Vref0+Vdata), and supplies the pixel data voltage as a gradation signal to the data line.

### CROSS REFERENCE TO RELATED APPLICATIONS

This is a Continuation Application of PCT Application No. PCT/JP2006/319170, filed Sep. 27, 2006, which was published under PCT Article 21 (2) in Japanese.

This application is based upon and claims the benefit of priority from prior Japanese Patent Application No. 2005-279492, filed Sep. 27, 2005, the entire contents of which are incorporated herein by reference.

### BACKGROUND OF THE INVENTION

1. Field of the Invention

The present invention relates to a display device and a driving method for the display device, and particularly relates to a display device which includes a display panel (display pixel array) where a plurality of current-driven (or current-controlled) light emitting elements that emit light with a predetermined luminance gradation by supplying an electric current corresponding to display data are arranged, and the driving method for the display device.

2. Description of the Related Art

In recent years, as next-generation display devices to supersede liquid crystal display devices, light emitting element display devices (light emitting element displays) that have display panels where organic electroluminescence elements (organic EL elements), inorganic electroluminescence elements (inorganic EL elements), or light emitting elements such as light emitting diodes (LED) (self-luminous optical elements) are arranged into a matrix pattern are being actively researched and developed.

In comparison with publicly-known liquid crystal display devices, light-emitting element displays of the active-matrix-driving type have a high display response rate and no view-angle dependence, and enable to accomplish high luminance, high contrast, and high degree of fineness of the display image quality. Further, since light emitting element displays do not require a backlight, unlike liquid crystal display devices, they have highly advantageous features, such that their thickness, weight and power consumption can be further reduced.

In such light emitting element displays, various driving control mechanisms and control methods for controlling operations of the light emitting elements (emitting state) are proposed. For example, Jpn. Pat. Appln. KOKAI Publication No. 8-330600 (Page 3, FIG. 4) discloses a constitution which has a driving circuit composed of light emitting elements and a plurality of switching elements for driving and controlling light emission of the light emitting elements for each display pixel composing a display panel.

FIG. 21 is an equivalent circuit diagram illustrating a constitutional example of a display pixel (driving circuit and light emitting element) applied to light emitting element displays of the conventional technique.

As shown in FIG. 21, a display pixel EMp applied to the light emitting element display (organic EL display device) disclosed in Jpn. Pat. Appln. KOKAI Publication No. 8-330600 includes: a driving circuit DCp which includes a thin film transistor (TFT) Tr111 where a gate terminal is connected to a scanning line SLp and a source terminal and a drain terminal are connected to a data line DL and a contact point N111 respectively, and a thin film transistor Tr112 where a gate terminal is connected to the contact point N111 and a predetermined power supply voltage Vdd is applied to a source terminal; and an organic EL element (current-controlled light emitting element) OEL where an anode terminal is connected to a drain terminal of the thin film transistor Tr112 in the driving circuit DCp and a ground potential Vgnd lower than the power supply voltage Vdd is applied to a cathode terminal. In FIG. 21, Cp denotes a capacity component formed between a gate and a source of the thin film transistor Tr112.

In the display pixel EMp having such a constitution, when an on-level scanning signal Ssel is applied to the scanning line SLp, the thin film transistor Tr111 is turned on so as to be set into a selected state. In synchronization with this selected timing, a gradation voltage Vpxp corresponding to display data is applied to the data line DLp, so that an electric potential corresponding to the gradation voltage Vpxp is applied to the contact point N111 (namely, the gate terminal of the thin film transistor Tr112) via the thin film transistor Tr111.

As a result, the thin film transistor Tr112 is turned on into a conduction state corresponding to the electric potential of the contact point N111 (precisely, a potential difference between the gate and the source) (namely, conduction state corresponding to the gradation voltage Vpxp), and a predetermined driving current is applied from the power supply voltage Vdd to the ground potential Vgnd via the thin film transistor Tr112 and the organic EL element OEL, so that the organic EL element OEL emits light with a luminance gradation corresponding to the display data (gradation voltage Vpxp).

When a scanning signal Ssel at an off level is applied to the scanning line SLp, the thin film transistor Tr111 of the display pixel EMp is turned off and is set into a unselected state, so that the data line DLp and the driving circuit DCp are electrically disconnected. At this time, when the electric potential applied to the gate terminal (contact point N111 of the thin film transistor Tr112 is retained in a capacitor Cp, a predetermined voltage is applied between the gate and the source of the thin film transistor Tr112, so that the thin film transistor Tr112 is maintained in the on state.

Therefore, similarly to the light emitting operation in the selected state, a predetermined driving current is applied from the power supply voltage Vdd to the organic EL element OEL via the thin film transistor Tr112, so that the light emitting operation is continued. This light emitting operation is controlled so as to be continued until the gradation voltage Vpxp corresponding to next display data is applied (written), namely, for one frame period, for example.

In such a driving method, when a value of the gradation voltage Vpxp applied to the display pixel EMp (specifically, the gate terminal of the thin film transistor Tr112 in the driving circuit DCp) is adjusted, a value of the driving current applied to the organic EL element OEL is controlled so that the light emitting operation is performed with a predetermined luminance gradation. For this reason, this method is called as a voltage gradation specifying system (or voltage gradation specifying driving).

### BRIEF SUMMARY OF THE INVENTION

However, in the driving circuit DCp which copes with the voltage gradation specifying system, electric current paths are connected in series on the organic EL element OEL, and when an element property of the thin film transistor Tr112 for driving (particularly, a threshold voltage property) such that a driving current corresponding to the display data (gradation voltage Vpxp) is applied in both the selected and unselected states changes (shifts) depending on operating time and driving histories, a relationship between the gate voltage (voltage at the contact point 111) and the driving current applied between the source and the drain (source-drain voltage) changes, and thus a value of the driving current applied at a predetermined gate voltage fluctuates (for example, reduces). For this reason, it is difficult to stably realize the light emitting operation with a luminance gradation suitable for the display data for a long period.

When element properties (threshold voltages) of the thin film transistors Tr111 and Tr112 in the display panel 110P disperse in each display pixel EMp (driving circuit DCp) or in each display panel 110P according to manufacturing lots, the dispersion of the value of the driving current becomes larger in each display pixel or each display panel, and the gradation cannot be properly controlled. As a result, display devices having a uniform display image quality cannot be provided.

Particularly, when an amorphous silicon thin film transistor, whose manufacturing process is already established and which can be manufactured relatively easily and inexpensively, is applied to the thin film transistors composing the driving circuits provided to the display pixels, since a DC voltage is applied for a long time, a threshold voltage greatly fluctuates. For this reason, the above-mentioned light emitting properties and display image quality are easily deteriorated.

Therefore, in view of the above problems, it is an object of the present invention to provide a display device having a favorable and uniform display image quality which applies a driving current having a value suitable for display data so as to be capable of driving light emission of display pixels (light emitting elements) arranged on a display panel with a luminance gradation suitable for the display data, and a driving method for the display device.

To obtain the above object, the invention described in claim 1 discloses a display device which displays image information corresponding to display data, comprising: a display panel where a plurality of display pixels, each having a current-controlled light emitting element and a driving circuit for supplying a driving current to the light emitting element are arranged at intersecting points between a plurality of selection lines and data lines disposed in a column direction and a row direction, respectively a selection driving section which applies a selection signal to the display pixels on the lines on the display panel so as to set the display pixels into a selected state; and a data driving section which generates a gradation signal corresponding to the display data so as to apply the gradation signal to the display pixels on the selection lines set into the selected state, wherein the data driving section includes at least: a constant current supplying section which supplies a constant current to the data lines; and a voltage detecting section which detects voltages of the data lines at the time when the constant current is supplied to the driving circuits of the display pixels set into the selected state via the data lines.

The invention described in claim 2 discloses a display device according to claim 1, wherein the data driving section further includes a gradation signal generating section which corrects a gradation voltage having a value corresponding to the display data based on the voltages of the data lines detected by the voltage detecting section so as to generate the gradation signal.

The present invention described in claim 3 discloses a display device according to claim 2, wherein the driving circuits have a driving element which includes a control terminal and an electric current path to which an electric current corresponding to a voltage value of the control terminal is applied and whose one terminal is electrically connected to the data lines and the light emitting elements so that the driving current is supplied to the light emitting elements, the data driving section further includes a gradation voltage generating section which generates a gradation voltage having a value corresponding to the display data, and the gradation signal generating section generates a pixel data voltage based on the voltages of the data lines detected by the voltage detecting section, the gradation voltage generated by the gradation voltage generation section and voltages intrinsic to the driving elements of the display pixels so as to apply the pixel data voltage as the gradation signals to the display pixels via the data lines, respectively.

The present invention described in claim 4 discloses a display device according to claim 3, wherein the voltages intrinsic to the driving elements are voltages between both ends of the electric current paths when the threshold voltages of the driving elements are 0V and the constant currents are applied to the electric current paths of the driving elements.

The present invention described in claim 5 discloses a display device according to claim 1, wherein the driving circuits have a driving element which includes a control terminal and an electric current path to which an electric current corresponding to a voltage of the control terminal is applied and whose one end is electrically connected to the data lines and the light emitting elements so that the driving currents are supplied to the light emitting elements, and

the voltages of the data lines detected by the voltage detecting section have a value corresponding to the voltages of the control terminals at the time when the constant currents is applied to the electric current paths of the driving elements via the data lines.

The present invention described in claim 6 discloses a display device according to claim 5, wherein the driving elements are electric field effect type thin film transistors, the electric current paths are formed between source and drain terminals of the thin film transistors, the control terminals are gate terminals, and the source terminals are electrically connected to the data lines and to one ends of the light emitting elements.

The present invention described in claim 7 discloses a display device according to claim 1, wherein an operation for supplying the constant current to the data lines by means of the constant current supplying section so as to detect the voltages of the data lines by means of the voltage detecting section is performed prior to an operation for applying the gradation signal to the display pixels by means of the selection driving section and the data driving section so as to allow the light emitting elements provided to the display pixels to emit light with a luminance gradation corresponding to the display data.

The present invention described in claim 8 discloses a display device according to claim 1, wherein the driving circuit has a control terminal and an electric current path to which an electric current corresponding to a voltage of the control terminal is applied and whose one end is electrically connected to the data line and the light emitting element so that the driving current is supplied to the light emitting element, and the constant current is set to a value to a voltage value such that the voltage of the control terminal becomes higher than the threshold voltage of the driving element when the constant current is applied to the electric current path of the driving element.

The present invention described in claim 9 discloses a display device according to claim 8, wherein the constant current is set to a value such that the voltage of the control terminal becomes higher than a voltage obtained by adding the threshold voltage of the driving element and the gradation voltage corresponding to the display data when the constant current is applied to the electric current path of the driving element.

The present invention described in claim 10 discloses a display device according to claim 1, wherein the voltage detecting section has a voltage retaining section which temporarily retains voltage components corresponding to the voltages of the data lines.

The present invention described in claim 11 discloses a display device according to claim 1, wherein the voltage detecting section has a memory section which stores detected data corresponding to the detected voltages of the data lines individually according to each corresponding display pixel.

The present invention described in claim 12 discloses a display device according to claim 1, wherein the driving circuit has a driving element which has a control terminal and an electric current path to which an electric current corresponding to a voltage of the control terminal is applied and whose one end is electrically connected to the data line and the light emitting element so that the driving current is supplied to the light emitting element, and the voltage detecting section has a memory section which stores the detected voltages of the data lines and threshold data generated based on voltages intrinsic to the corresponding driving elements on the display pixels individually according to corresponding respective display pixels.

The present invention described in claim 13 discloses a display device according to claim 12, wherein the voltage intrinsic to the driving element is a voltage between both terminals of the electric current path at the time when the threshold voltage of the driving element is 0V and the constant current is applied to the electric current path of the driving element.

The present invention described in claim 14 discloses a display device according to claim 1, wherein the data driving section has a constant voltage supplying section which applies a constant current to the data lines, and an operation for applying the constant voltage to the data lines by means of the constant voltage supplying section is performed prior to an operation for supplying the constant current to the data lines by means of the electric current supplying section.

The present invention described in claim 15 discloses a display device according to claim 14, wherein the constant voltage applied by the constant voltage supplying section is set to a value which is higher than the voltages of the data lines at the time when the constant current is supplied to the data lines by the constant current supplying section.

The present invention described in claim 16 discloses a display device according to claim 1, wherein the driving circuit includes at least: a first switch section whose contact with the light emitting element is connected to one end of an electric current path so that a predetermined supply voltage is applied to the other end of the electric current path; a second switch section where the selection signal is applied to a control terminal, the supply voltage is applied to one end of the electric current path, and the control terminal of the first switch section is connected to the other end of the electric current path; and a third switch section where the selection signal is applied to a control terminal, the data line is connected to one end of the electric current path and the connection contact point is connected to the other end of the electric current path, the driving element is the first switch section, and the voltage detecting section detects a voltage corresponding to an electric potential of the connection contact point of the first switch section.

The present invention described in claim 17 discloses a display device according to claim 1, wherein the light emitting element is an organic electroluminescence element.

The present invention described in claim 18 discloses a driving method for controlling a display device so that image information corresponding to display data is displayed, the display device including a display panel, where a plurality of display pixels, each having a current-controlled light emitting element and a driving circuit for supplying a driving current to the light emitting element are arranged at intersecting points between a plurality of selection lines and data lines disposed in a column direction and a row direction, respectively, and a constitution such that a selection signal is sequentially applied to the display pixels in respective selection lines on the display panel so that the display pixels are set into a selected state, and a gradation signal corresponding to display data for displaying desired image information is applied to the display pixels in the rows set into the selected state in synchronization with the selection timing so that the display pixels are allowed to emit light with predetermined luminance gradation and the desired image information is displayed on the display panel, the driving method comprising at least: an operation for supplying a constant current to the data lines prior to an operation for applying the gradation signal to the display pixels; and an operation for detecting voltages of the data lines at the time when the constant current is supplied to the display pixels set into the selected state via the data lines.

The present invention described in claim 19 discloses a driving method according to claim 18, wherein the driving circuit has a control terminal and an electric current path to which an electric current corresponding to a voltage of the control terminal is applied and whose one end is electrically connected to the data line and the light emitting element so that the driving current is supplied to the light emitting element, and

the driving method further comprises an operation for generating a pixel data voltage based on the detected voltages of the data lines, a gradation voltage generated according to the display data and voltages intrinsic to the driving elements on the display pixels so as to apply the pixel data voltage as the gradation signal to the display pixels via the data line.

The present invention described in claim 20 discloses a driving method according to claim 19, wherein the voltages intrinsic to the driving elements are a voltage between both ends of the electric current path at the time when threshold voltages of the driving elements are 0V and the constant current is applied to the electric currents of the driving elements.

The present invention described in claim 21 discloses a driving method according to claim 18, wherein the constant current is set to a value such that the voltage of the control terminal becomes higher than threshold voltages of the driving elements when the constant current is applied to the electric current paths of the driving elements.

The present invention described in claim 22 discloses a driving method according to claim 21, wherein the constant current is set to a value such that the voltage of the control terminal becomes higher than a voltage obtained by adding the threshold voltage of the driving element and the gradation voltage corresponding to the display data when the constant current is applied to the electric current paths of the driving elements.

The present invention described in claim 23 discloses a driving method according to claim 18, further comprising an operation for applying a constant current to the data lines prior to the operation for supplying the constant current to the data lines.

The present invention described in claim 24 discloses a driving method according to claim 23, wherein the constant voltage is set to a value higher than the voltages of the data lines at the time when the constant current is supplied to the data lines.

The present invention described in claim 25 discloses a driving method according to claim 18, wherein the operation for detecting the voltages of the data lines at the time of supplying the constant current to the display pixels set into the selected state via the data lines is performed in every display driving period at which the display pixels emit light with a luminance gradation corresponding to the display data.

The present invention described in claim 26 discloses a driving method according to claim 18, wherein the operation for detecting the voltages of the data lines at the time of supplying the constant current to the display pixels set into the selected state via the data lines is performed intermittently in an arbitrary processing cycle period in the case where a display driving period for allowing the display pixels to emit light with a luminance gradation corresponding to the display data is determined as one processing cycle period.

### BRIEF DESCRIPTION OF THE SEVERAL VIEWS OF THE DRAWING

FIG. 1 is a main section constitutional diagram illustrating a display device according to a first embodiment of the present invention.

FIG. 2 is a schematic block diagram illustrating one constitutional example of a gradation voltage generating section applied to the display device according to the first embodiment.

FIG. 3 is a schematic block diagram illustrating one constitutional example of a voltage retaining section applied to the display device according to the first embodiment.

FIG. 4 is a timing chart illustrating one example of a driving method in the display device (display driving device and display pixel) according to the first embodiment.

FIG. 5 is a conceptual diagram illustrating an electric current setting operation in the display device (display driving device and display pixel) according to the first embodiment.

FIG. 6 is an equivalent circuit diagram for explaining an operating state in a voltage setting operation according to the first embodiment.

FIG. 7 is a conceptual diagram illustrating a voltage detecting operation in the display device (display driving device and display pixel) according to the first embodiment.

FIG. 8 is a conceptual diagram illustrating a pixel data-writing operation in the display device (display driving device and display pixel) according to the first embodiment.

FIG. 9 is a diagram illustrating a voltage-current characteristic of a thin film transistor.

FIG. 10 is a conceptual diagram illustrating a light emitting operation in the display device (display driving device and display pixel) according to the first embodiment.

FIG. 11 is a schematic block diagram illustrating another constitutional example of the voltage retaining section applied to the display device according to the first embodiment.

FIG. 12 is a main section constitutional diagram illustrating the display device according to a second embodiment of the present invention.

FIG. 13 is a timing chart illustrating one example of a driving method in the display device (display driving device and display pixel) according to the second embodiment.

FIG. 14 is a conceptual diagram illustrating the voltage setting operation in the display device (display driving device and display pixel) according to the second embodiment.

FIG. 15 is a conceptual diagram illustrating the electric current setting operation in the display device (display driving device and display pixel) according to the second embodiment.

FIG. 16 is a conceptual diagram illustrating the voltage detecting operation in the display device (display driving device and display pixel) according to the second embodiment.

FIG. 17 is a conceptual diagram illustrating the pixel data-writing operation in the display device (display driving device and display pixel) according to the second embodiment.

FIG. 18 is a conceptual diagram illustrating the light emitting operation in the display device (display driving device and display pixel) according to the second embodiment.

FIG. 19 is a simulation result illustrating a relationship between a value of a constant voltage in the voltage setting operation and a time change of a constant current in the electric current setting operation according to the second embodiment (1).

FIG. 19B is a simulation result illustrating the relationship between the value of the constant voltage in the voltage setting operation and the time change of the constant current in the electric current setting operation according to the second embodiment (2).

FIG. 19C is a simulation result illustrating the relationship between the value of the constant voltage in the voltage setting operation and the time change of the constant electric current in the electric current setting operation according to the second embodiment (3).

FIG. 20 is a schematic constitutional diagram illustrating one example of an entire constitution of the display device according to the present invention.

FIG. 21 is an equivalent circuit diagram illustrating a constitutional example of a display pixel (driving circuit and light emitting element) applied to a light emitting element display in a conventional technique.

### DETAILED DESCRIPTION OF THE INVENTION

### First Embodiment

A display device and a driving method according to an embodiment of the present invention are described in detail below.

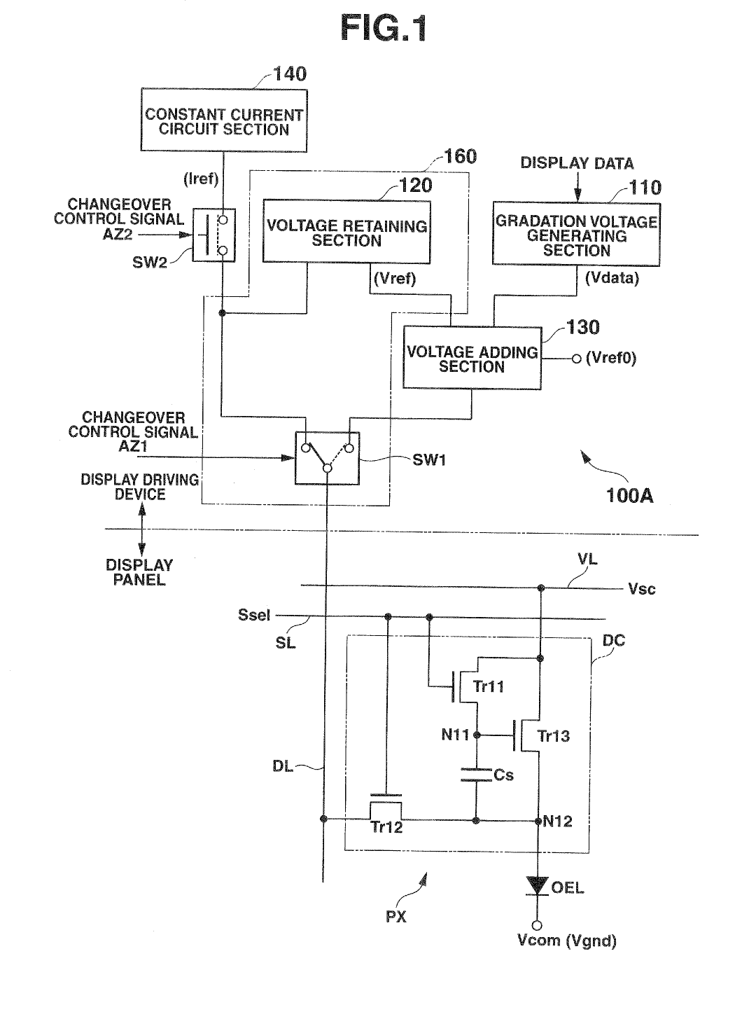

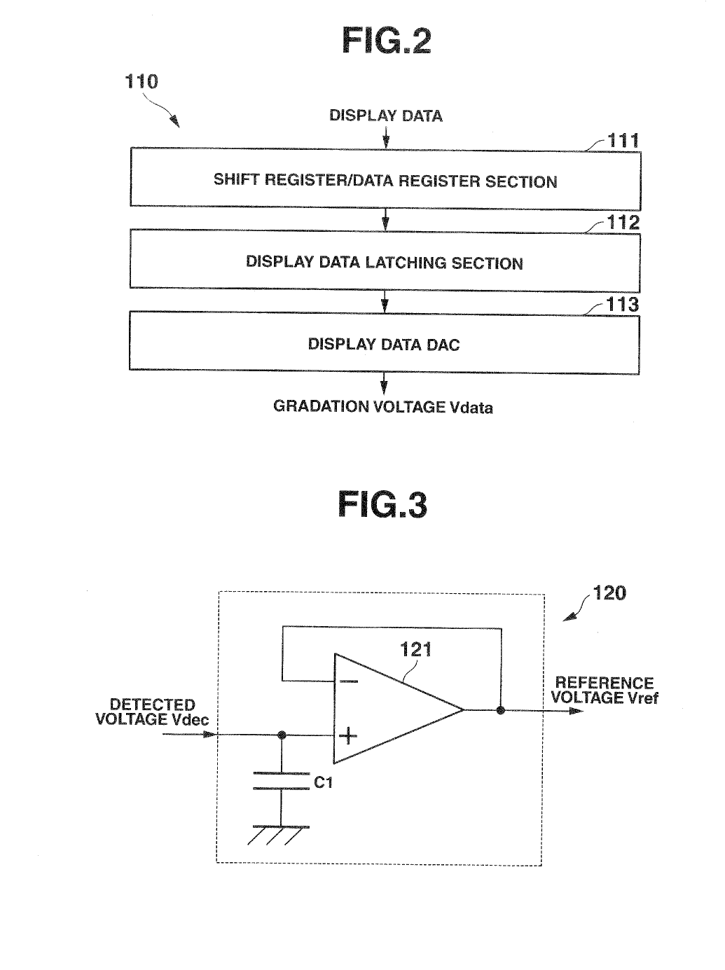

FIG. 1 is a main section constitutional diagram illustrating the display device according to the first embodiment of the present invention. A relationship between specified display pixels arranged on a display panel of the display device and a display driving device, which controls to drive light emission of the display pixels, is described in detail. FIG. 2 is a schematic block diagram illustrating one constitutional example of a gradation voltage generating section applied to the display device according to the first embodiment, and FIG. 3 is a schematic block diagram illustrating one constitutional example of a voltage retaining section applied to the display device according to the first embodiment.

(Display Driving Device)

As shown in FIG. 1, a display driving device (data driving section) 100A which can be applied to the display device of the present invention has: a gradation voltage generating section (gradation voltage generating section) 110 which generates a gradation voltage data having a voltage value corresponding to display data; a constant current circuit section (constant current supplying section) 140, which supplies a constant current, Iref having a predetermined value, to a display pixel PX arranged on the display panel; a voltage retaining section 120 which detects and retains a voltage of a data line DL at the time of supplying the constant current Iref to the display pixel PX by the constant current circuit section 140 as a detected voltage Vdec; a voltage adding section (gradation signal generating section) 130 which applies a pixel data voltage Vpix, which is generated by adding and subtracting the gradation voltage Vdata, a reference voltage Vref corresponding to the detected voltage Vdec and an intrinsic voltage Vref0 (described in detail later) determined based on the constant current Iref and a design parameter of a driving transistor (driving element) provided to the display pixel PX (driving circuit DC, mentioned later), as a gradation signal to the display pixel PX via the data line DL at the time of writing display data into the display pixel PX; a changeover switch SW1 which selectively switches over a connection state between the data line DL and the voltage adding section 130 or the constant current circuit section 140; and a changeover switch SW2 which switches over a connection state (connection, disconnection) between the changeover switch SW1 and the constant current circuit section 140. The voltage retaining section 120 and the changeover switch SW1 compose a voltage detecting section 160.

The gradation voltage generating section 110 is basically composed of, as shown in FIG. 2, a shift register/data register section 111, a display data latching section 112, and a display data digital/analog converter (hereinafter, “display data D/A converter”, and in the drawing, “display data DAC” for convenience) 113.

The shift register/data register section 111 has, for example, a shift register which sequentially outputs a shift signal and a data register which sequentially loads display data (luminance gradation data) supplied as a digital signal based on the shift signal. The shift register/data register section 111 sequentially loads display data (serial data) of the display pixels PX for one line of the display panel so as to collectively transmit them as parallel data to the display data latching section 112.

The display data latching section 112 retains the display data of the display pixels PX for one line loaded by the shift register/data register section 111 correspondingly to the data lines DL (display pixels PX) on respective rows.

The display data D/A converter (display data DAC) 113 converts digital signal voltages of the display data retained in the display data latching section 112 into analog signal voltages based on a reference voltage supplied from a power supplying section, not shown, and converts the analog signal voltages into gradation voltages Vdata having a predetermined value for enabling organic EL elements (current-controlled light emitting elements) OEL provided to the display pixels PX to perform the light emitting operation with a luminance gradation corresponding to the display data so as to output the gradation voltages Vdata.

The voltage retaining section 120 has a constitution which temporarily retains the detected voltages Vdec and outputs corresponding voltages (reference voltages Vref), and as shown in FIG. 3, is composed of a capacitance C1 for retaining electric charges and a buffer circuit (voltage follower circuit) 121 composed of an operational amplifier.

The voltage adding section 130 includes a voltage adding circuit or the like using an operational amplifier, and adds and subtracts the gradation voltage Vdata generated by the gradation voltage generating section 110, the reference voltage Vref output from the voltage retaining section 120 and the intrinsic voltage Vref0 determined in advance based on the design parameter of the driving transistor provided to each display pixel PX according to a formula (1), and generates a pixel data voltage Vpix so as to output it as the gradation signal to the data line DL via the changeover switch SW1.

Vpix=Vref−Vref0+Vdata (1)

That is, a voltage value of the data line DL (namely, the voltage of the source terminal of the driving transistor provided to the display pixel PX) at the time of supplying the constant current Iref to the display pixel PX is detected by the voltage detecting section 160, loaded and retained in the voltage retaining section 120. When display data is written into the display pixel PX (at the time of the pixel data-writing operation), the generated pixel data voltage Vpix is output from the voltage adding section 130.

The constant current circuit section 140 supplies the constant current Iref having a predetermined value (negative polarity) to the data line DL, and applies the constant current Iref to the electric current path (between source and drain) of the driving transistor (driving element) in the driving circuit DC provided to the display pixel PX. As a result, a voltage component corresponding between the gate and the source of the driving transistor is retained, and a predetermined voltage Vts=Va (corresponding to the detected voltage Vdec) is generated at the source terminal (between the drain and source terminals) of the driving transistor. In the first embodiment, when the constant current Iref having negative polarity is applied to the data line DL, the constant current Iref is applied so as to be attracted from the data line DL (display pixel PX) in the direction of the constant current circuit section 140.

The value of the constant current Iref supplied from the constant current circuit section 140 is specifically set so that when the constant current Iref is supplied to the display pixel PX via the data line DL from the constant current circuit section 140, a voltage Vts=Va (voltage of the data line DL; the detected voltage Vdec) generated at the source terminal (between the source and drain terminals) of the driving transistor in the display pixel PX is higher than a threshold voltage Vth of the driving transistor (Vref>Vth). Preferably, the constant current Iref is set so that the voltage Vts=Va generated between the drain and source terminals of the driving transistor in the display pixel PX is higher than a voltage value (Vth+Vdata) obtained by adding the threshold voltage Vth of the driving transistor and the gradation voltage Vdata corresponding to display data generated by the gradation voltage generating section 110 at the time of the voltage writing operation (Vref>Vth+Vdata).

The changeover switch SW1 selectively connects the data line DL to the voltage adding section 130 or the constant current circuit section 140 and the voltage retaining section 120 based on a changeover control signal AZ1 supplied from a system controller, not shown. That is, the changeover switch SW1 controls switching so that the data line DL is connected to the constant current circuit section 140 and the voltage retaining section 120 at the time of the electric current setting operation for supplying the constant current Iref to the display pixel PX via the data line DL and the voltage detecting operation for detecting the voltage of the data line DL. The changeover switch SW1 controls switching so that the data line is connected to the voltage adding section 130 at the time of the image data-writing operation for supplying the pixel data voltage Vpix to each of the display pixels PX.

The changeover switch SW2 switches over a connection state (connection, disconnection) between the constant current circuit section 140 and the data line DL (changeover switch SW1) via the changeover switch SW1 based on a changeover control signal AZ2 supplied from the system controller, not shown, so as to control switching of the supplying state (supply, non-supply) of the constant current Iref from the constant current circuit section 140 to the data line DL.

(Display Pixel)

The display pixel PX applicable to the display device of the present invention is, as shown in FIG. 1, arranged near an intersecting point between a selection line SL disposed in a line direction (horizontal direction in the drawing) of the display panel and the data line DL disposed in a row direction (vertical direction in the drawing). The display pixel PX includes an organic EL element OEL as a current-controlled light emitting element, and a driving circuit DC which supplies a driving current having a value corresponding to the display data on the organic EL element OEL

The driving circuit DC can be constituted so as to have: a thin film transistor (second switching section) Tr11 where a gate terminal (control terminal) is connected to the selection line SL, and a drain terminal and a source terminal (electric current paths) are connected to a power supply line VL and a contact point N11 to which a predetermined supply voltage Vsc is applied; a thin film transistor (third switching section) Tr12 where a gate terminal (control terminal) is connected to the selection line SL, and a source terminal and a drain terminal (electric current paths) are connected to the data line DL and a contact point N12, respectively; a thin film transistor (driving element, first switching section, driving transistor) Tr13 where a gate terminal (control terminal) is connected to the contact point N11, and a drain terminal and a source terminal (electric current paths) are connected to the power supply line VL and the contact point N12 (connecting contact point), respectively; and a capacitor Cs which is connected between the contact point N11 and the contact point N12 (between the gate and source terminals of the thin film transistor Tr13). The thin film transistor Tr13 corresponds to the driving transistor where a voltage (voltage of the data line) on the source side is detected by the voltage detecting section 160 in the display driving device 100A.

In the organic EL element OEL, an anode terminal is connected to the contact point N12 of the driving circuit DC, and a common voltage Vcom is applied to a cathode terminal.

The electric potential of the common voltage Vcom is equivalent to an electric potential of a supply voltage Vsc (=Vscl) set to be a low potential (L), or higher than the electric potential of the supply voltage Vsc, or an electric potential such that a voltage (Vscl−Vcom) applied between the anode and cathode terminals of the organic EL element OEL is lower than a threshold voltage (Velth) of the organic EL element OEL and an electric current is not applied to the organic EL element OEL at a pixel data-writing period for which the pixel data voltage corresponding to display data is supplied to the driving circuit DC in a driving control operation, mentioned later. Further, the common voltage Vcom is lower than a supply voltage Vsc (=Vsch) set at a high potential (H) at the light emitting period for which a driving current is supplied to the organic EL element (light emitting element) OEL and the organic EL element emits light with a predetermined luminance gradation, and the voltage (Vsch−Vcom) applied between the anode and cathode terminals of the organic EL OEL is set to be higher than the threshold voltage (Velth) of the organic EL element OEL. As a result, the electric potential of the common voltage Vcom is set to a ground potential Vgnd (Vscl≦Vcom+Velth<Vsch).

The capacitor Cs may be a parasitic capacitance formed between the gate and the source of the thin film transistor Tr13, or the parasitic capacitance and a capacity element may be connected in parallel between the contact points N11 and N12. Element structures and properties of the thin film transistors Tr11 to Tr13 are not particularly limited, but all the thin film transistors Tr11 to Tr13 are composed of n-channel thin film transistors so as to be capable of being preferably applied to n-channel amorphous silicon thin film transistors. The following description refers to a case where all the thin film transistors Tr11 to Tr13 are composed of n-channel thin film transistors. The light emitting element, which is driven to emit light by the driving control DC, is not limited to the organic EL, element OEL, and other light emitting elements, such as light emitting diodes, may be used as long as they are current-controlled light emitting elements.

(Driving Method)

A driving method (driving control operation) for allowing the light emitting element of the display pixel to emit light with a desired luminance gradation in the display device according to the first embodiment is described below with reference to the drawing.

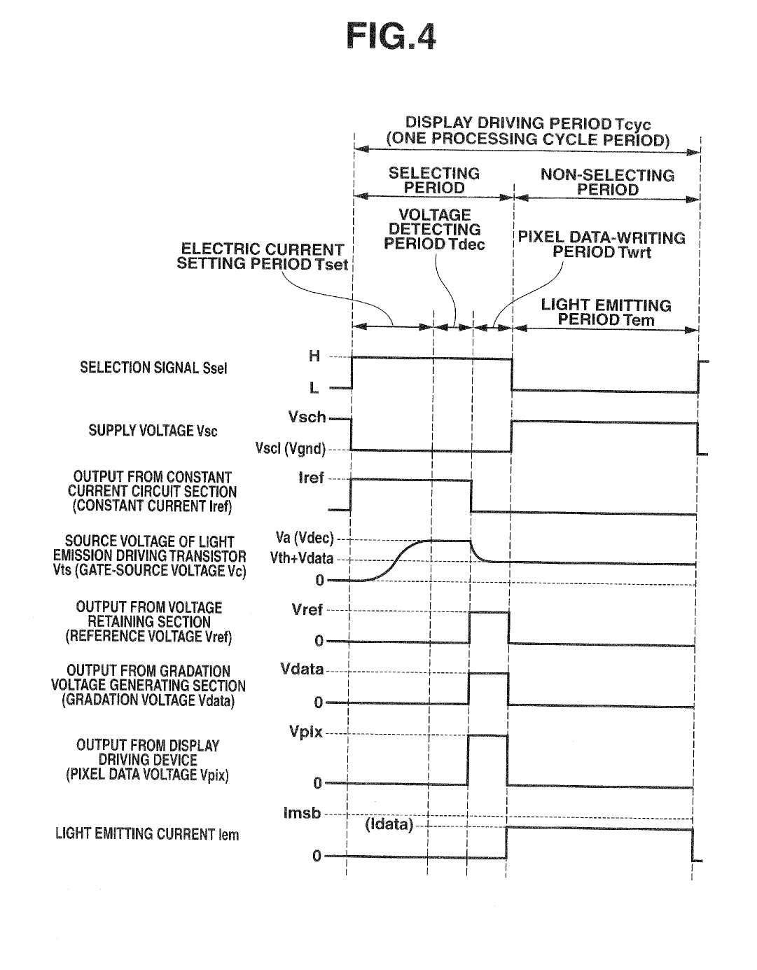

FIG. 4 is a timing chart illustrating one example of the driving method in the display device (display driving device and display pixel) according to the first embodiment.

As shown in FIG. 4, at a selection period in a display driving period Tcyc for allowing the display pixel PX to emit light with a predetermined luminance gradation as one processing cycle period, the driving control operation in the display device composed of the display driving device 100A and the display pixel PX having the above constitution roughly includes: an electric current setting operation (electric current setting period Tset) for supplying the constant current Iref to the display pixel PX (driving circuit DC); a voltage detecting operation (voltage detecting period Tdec) for detecting and retaining a voltage Vts (=Va) as a detected voltage Vdec after the voltage Vts (also the voltage of the data Line DL) generated at the source terminal of the driving transistor (thin film transistor Tr13) provided to the display pixel PX is saturated (converged) according to the electric current setting operation; and a pixel data-writing operation (pixel data-writing period Twrt for writing a pixel data voltage Vpix having a voltage value (Vref−Vref0+Vdata), which is obtained by adding or subtracting the reference voltage Vref (=Vdec) corresponding to the detected voltage Vdec, the gradation voltage Vdata corresponding to display data and the intrinsic voltage Vref0 determined based on the design parameter of the driving transistor (thin film transistor Tr13) on the display pixel PX, into the display pixel PX after the voltage detecting operation. At an unselected period in the display driving period Tcyc, the driving control operation includes a light emitting operation (light emitting period tem) for allowing the organic EL element OEL to emit light with a desired luminance gradation corresponding to the display data based on the pixel data voltage Vpix written into the display pixel PX (driving circuit DC) by the pixel data-writing operation (Tcyc≧Tset+Tdec+Twrt+Tem).

The respective control operations are described below.

(Electric Current Setting Operation)

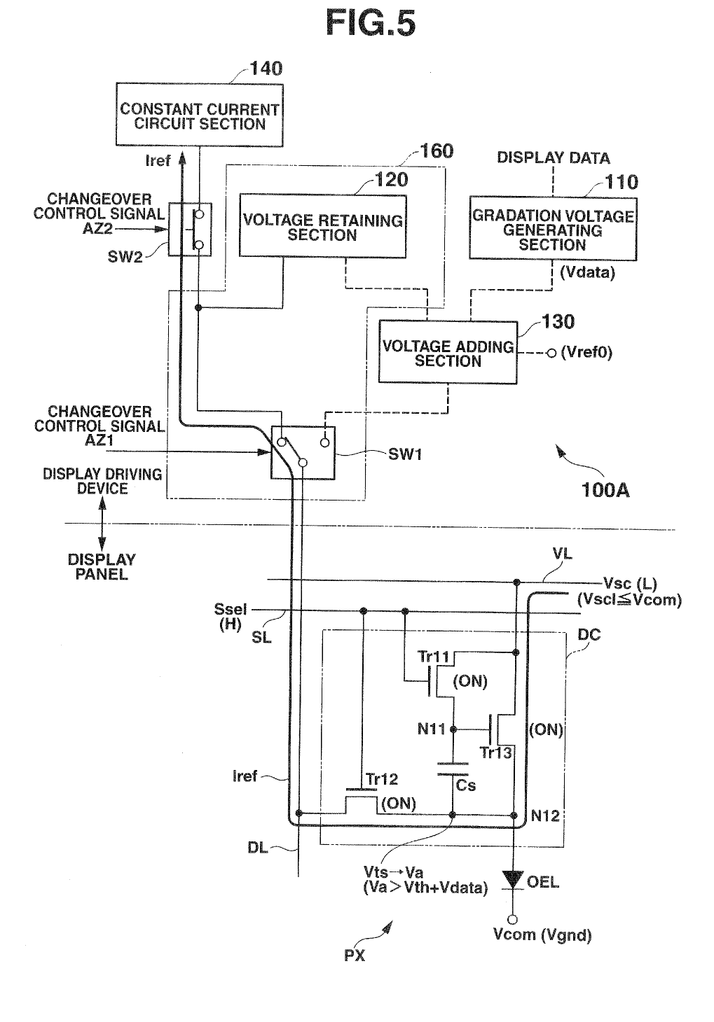

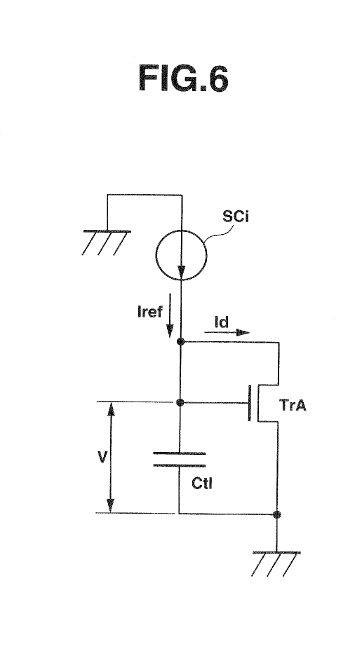

FIG. 5 is a conceptual diagram illustrating the electric current setting operation in the display device (display driving device and display pixel) according to the first embodiment, and FIG. 6 is an equivalent circuit diagram for explaining the operating state in the voltage setting operation according to the first embodiment.

At the electric current setting period Tset, as shown in FIG. 4, the on-level selection signal Ssel (high level; H) is applied to the selection line SL of the driving circuit DC, and the supply voltage Vsc (=Vscl) of a low potential (L) is applied to the power supply line VL. The supply voltage Vsc (=Vscl) of a low potential may be a ground potential Vgnd, for example.

On the other hand, in synchronization with this timing, the changeover switch SW1 is switched so as to be connected to the constant current circuit section 140 and the voltage retaining section 120 based on changeover control signals AZ1 and AZ2, and the changeover switch SW2 is set into an on state (conduction state). As a result, as shown in FIG. 5, the constant current Tref output from the constant current circuit section 140 is supplied to the data line DL via the changeover switches SW2 and SW1. When the constant current Iref having a negative current value (negative polarity) is output from the constant current circuit section 140, the constant current Iref is applied from the data line DL via the changeover switches SW1 and SW2 to the constant current circuit section 140 (namely, the constant current Iref is attracted to the display driving device 100A).

As a result, when the thin film transistors Tr11 and Tr12 provided to the driving circuit DC composing the display pixel PX are turned on (namely, the display pixel PX is set into a selected state), the supply voltage Vsc (=Vscl=Vgnd) is applied to the gate terminal (the contact point N1 as one end of the capacitor Cs) of the thin film transistor Tr13 via the thin film transistor Tr11, and a voltage component caused by the application of the constant current Iref to the constant current circuit section 140 from the data line DL is generated at the source terminal (the contact point N12 at the other end of the capacitor Cs) of the thin film transistor Tr13 via the thin film transistor Tr12.

That is, in the electric current setting operation, when the thin film transistor Tr11 is turned on, the gate and the drain of the thin film transistor TR13 are short-circuited so as to be set to substantially at the same potentials (Vsc=Vscl), and a voltage generated at the source terminal caused by the supply of the constant current Iref having a negative value is retained (written) as a voltage component between the gate and the source (capacitor Cs) of the thin film transistor Tr13.

The voltage component (the gate-source voltage) retained by the supply of the constant current Iref gradually rises (saturated) so as to be converged to a voltage value Va defined by the constant current Iref. However, when the voltage component is not less than the threshold voltage Vth of the thin film transistor Tr13, the thin film transistor Tr13 is turned on, and an electric current corresponding to the voltage component is applied from the power supply line VL in a direction of the display driving device 100A (constant current circuit section 140) via the thin film transistor Tr13, the contact point N12, the thin film transistor Tr12 and the data line DL.

In the first embodiment, the constant current Iref supplied from the constant current circuit section 140 is set so as to have a relatively large value such that at least a voltage (Vts=Va>Vth) larger than the threshold voltage Vth of the thin film transistor Tr13 can be generated at the source terminal (contact point N12) of the thin film transistor Tr13.

The value of the constant current Iref is described in detail below.

In the electric current setting operation, as shown in FIG. 5, the constant current Iref is applied to the display driving device 100A from the power supply line VL, via the thin film transistors Tr13, Tr12 and the data line DL. For this reason, as shown in FIG. 6, an electric current path is connected between a supply source SCi of the constant current Iref and the ground potential, so that the operation can be expressed by the equivalent circuit which is composed of a transistor element TrA (corresponding to the thin film transistor Tr13) where the gate and the drain are short-circuited and a capacity element Ct1 connected between the gate and the source of the transistor element TrA.

The capacity element Ct1 corresponds to a total sum of a retention capacity and a wiring capacity of the capacitor Cs and a gate capacity Cg of the transistor element TrA. That is, in the electric current setting operation of the first embodiment, electric charges of the voltage component corresponding to the constant current Iref are accumulated in the capacitor Cs, and also electric charges corresponding to a constant current Iset are accumulated in another capacity component parasitic on the electric current path passing from the power supply line VL to the data line DL.

In such an equivalent circuit, the constant current Iref supplied to the driving circuit DC in the voltage component retaining operation (writing operation) can be expressed by the following formula (11). In the formula (11), V denotes a potential difference generated at both ends of the capacity element Ct1 (between the gate and the source of the transistor element TrA), and μe denotes a dielectric constant of a gate insulation film of the transistor element TrA, Cg denotes a gate capacity of the transistor element TrA, and W and L denote a gate width and a gate length of the transistor element TrA.

$$\begin{matrix}Iref = Ctl \cdot \frac{d V}{d t} + {AV}^{2} \\ wherein , A = \frac{1}{2} Cg {μ}_{e} \frac{W}{L}\end{matrix} \} \qquad ( 11 )$$

In the formula (11), when t=0 and t=∞, the time change of the potential difference is set as shown in a formula (12), the time change of the electric current (writing current) Id applied to the transistor element TrA can be expressed by a formula (13). As a result, in the equivalent circuit shown in FIG. 6, the level of the electric current applied to the electric current path of the transistor element TrA is converted into a level of the gate-source voltage of the transistor element TrA, and the gate-source voltage is accumulated as electric charges in the capacity element Ctl (retained as a voltage component).

$$\begin{matrix}\begin{matrix}t = 0 : V = {V}_{0} \\ t = ∞ : V = \sqrt{\frac{Iref}{A}} = {V}_{∞}\end{matrix} \} & ( 12 ) \\ \begin{matrix}Id = {AV}_{∞}^{2} \cdot ( \frac{{V}_{∞} tanh \frac{t}{τ} + {V}_{0}}{{V}_{∞} + {V}_{0} tanh \frac{t}{τ}} ) \\ wherein , τ = \frac{Ct 1}{\sqrt{AIref}}\end{matrix} \} & ( 13 )\end{matrix}$$

In the equivalent circuit, a time constant at the time of supplying (writing) the constant current Iref can be expressed by Ctl×V/Id. At this time, when an electrostatic capacity of the capacity element Ct1 is 18 pF, the value of the electric current Id (a constant current Iref) applied to the transistor element TrA is 10 μA, the intrinsic voltage Vref0 determined based on the design parameter of the transistor element TrA is 3V, and the threshold voltage of the transistor element TrA is 1V, the time constant is calculated in such a manner that 90 pC/10 μA=9 μsec.

When the electric current setting period Tset is set to 50 μsec, for example, the saturation ratio of the voltage component retained between the gate and the source (capacitor Cs) of the transistor element TrA (thin film transistor TR13) (namely, writing ratio) becomes 99.9% due to the supply of the constant current Iref.

Even when the threshold voltage Vth of the transistor element TrA (thin film transistor Tr13) is changed so as to be 5V, for example, the time constant is calculated in such a manner that 144 pC/10 μA=15 μsec so that the writing ratio of 99.5% can be obtained.

As a result, when the constant current Iref is set to a relatively large value and thus even when the threshold voltage fluctuates (Vth shift) largely, the voltage component due to the constant current Iref can be sufficiently retained for a predetermined relatively short electric current setting period. The numerical values used in the calculation of the time constant are examples, but it is found from simulation experiments carried out by the inventors of this application that, in order to obtain a high writing ratio (about 100%) for a relatively short time of several dozen μsec, the value of the constant current Iref is set to not less than 1 μA to not more than 100 μA.

At the electric current setting period Tset, an electric current is not applied to the organic EL element OEL and thus the light emitting operation is not performed.

(Voltage Detecting Operation)

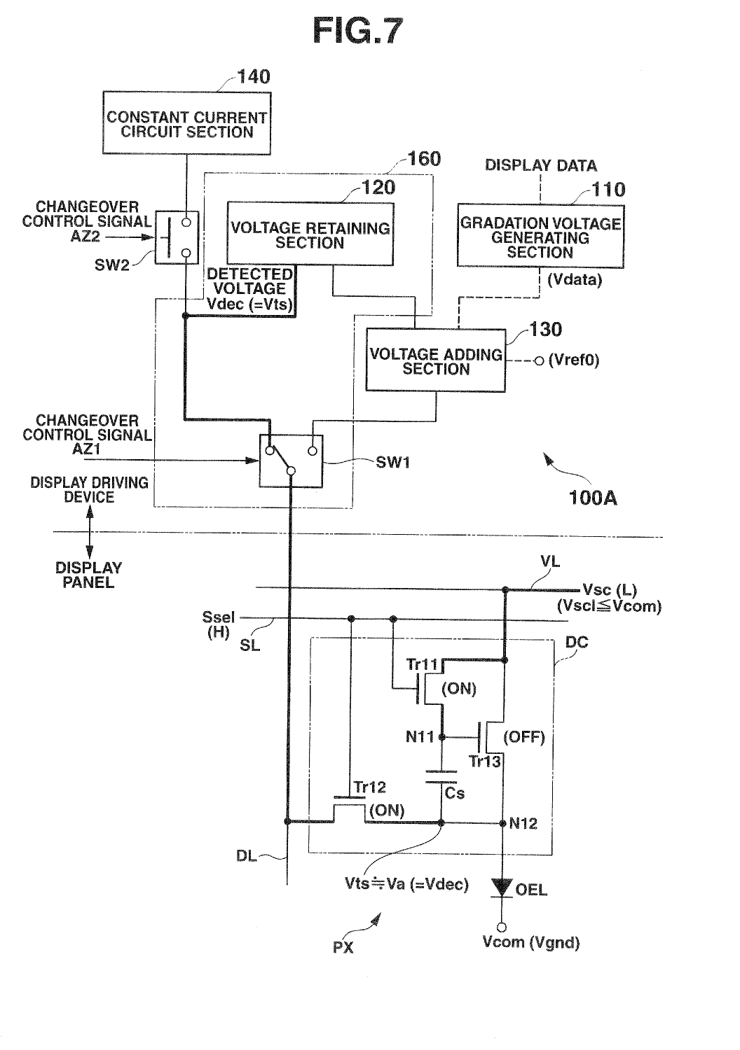

FIG. 7 is a conceptual diagram illustrating the voltage detecting operation in the display device (display driving device and display pixel) according to the first embodiment.

The voltage detecting operation is performed at a voltage detecting period Tdec after the electric current setting period Tset, and as shown in FIG. 4, when the constant current Iref is supplied in the electric current setting operation, the voltage detecting operation is performed after the voltage Vts (voltage of the data line DL) generated at the source terminal side (between the drain and source terminals) of the thin film transistor Tr13 is saturated (Vts≈Va) (after the electric current setting period Tset). The voltage detecting operation is performed in a state that the selection on-level signal Ssel is applied to the selection line SL and the supply voltage Vsc (=Vscl) of a low potential (L) is applied to the power supply line VL similarly to the electric current setting period Tset. When the changeover switch SW2 is set into a non-conduction state based on the changeover control signal AZ2, as shown in FIG. 7, the voltage detecting section 160, which has the voltage retaining section 120 electrically connected to the data line DL via the changeover switch SW1, detects the voltage of the data line DL (Vts≈Va) as the detected voltage Vdec, and the detected voltage Vdec is temporarily retained in the capacitance C1 for retaining electric charges in the voltage retaining section 120.

Since the thin film transistors Tr11 and Tr12 are set into the on state and the data line is electrically connected to the contact point N12, the voltage of the data line DL detected by the voltage detecting section 160 corresponds to the voltage Vts at the source terminal (the contact point N12) of the thin film transistor Tr13. The voltage Vts corresponds also to the voltage component retained between the gate and the source (capacitor Cs) of the thin film transistor Tr13. Since the thin film transistor Tr11 is in the on state and thus the gate and the drain of the thin film transistor Tr13 are electrically connected, the voltage Vts is also equal to the drain-source voltage of the thin film transistor Tr13.

At the voltage detecting period Tdec, an electric current is not applied to the organic EL element OEL and thus the light emitting operation is not performed.

(Pixel Data-Writing Operation)

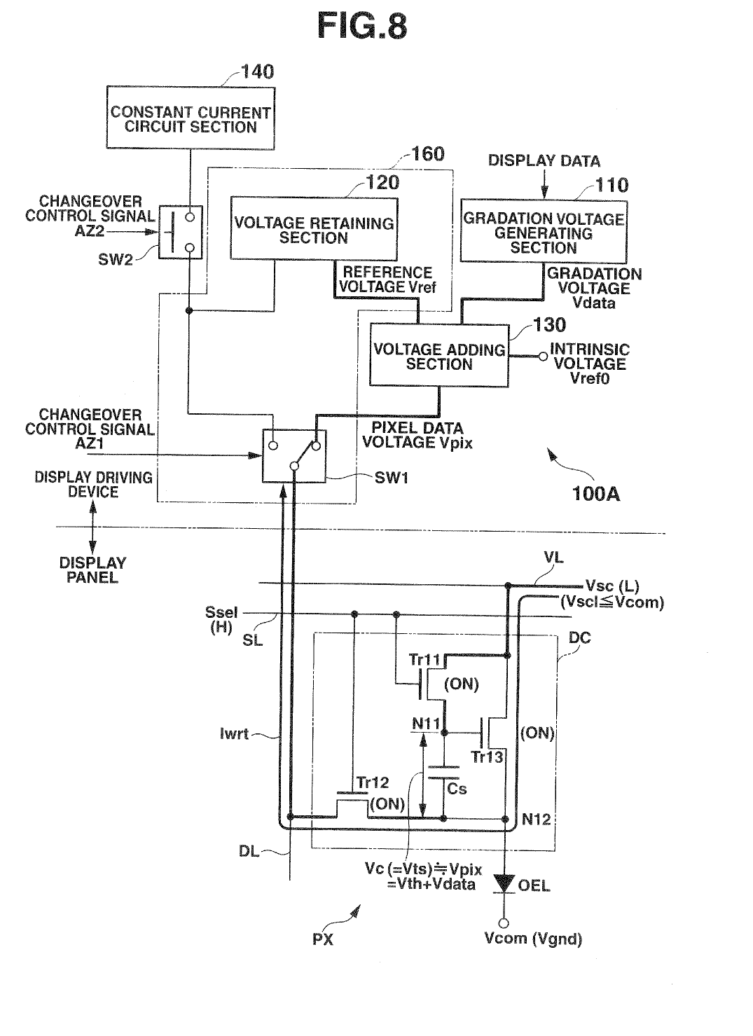

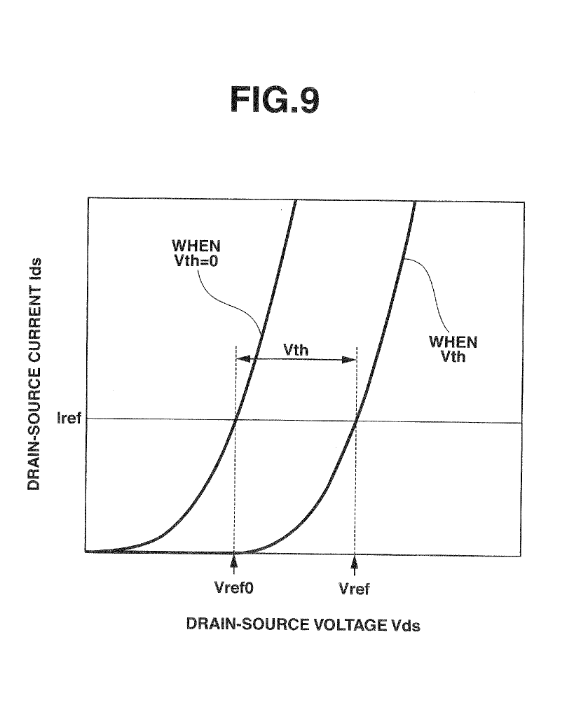

FIG. 8 is a conceptual diagram illustrating the pixel data-writing operation in the display device (display driving device and display pixel) according to the first embodiment. FIG. 9 is a diagram illustrating a volt-ampere characteristic of the thin film transistors.

At a pixel data-writing period Twrt, as shown in FIG. 4, similarly to the voltage detecting period Tdec, an on-level selection signal Ssel is applied to the selection line SL, and a supply voltage Vsc (=Vscl) of low potential (L) is applied to the power supply line VL. At the same time, the changeover switch SW1 is connected to the voltage adding section 130 and the changeover switch SW2 is set into a non-conduction state based on the changeover control signals AZ1 and AZ2. As shown in FIG. 8, a pixel data voltage Vpix is applied from the voltage adding section 130 to the display pixel PX via the data line DL.

Specifically, in the gradation voltage generating section 110, the shift register/data register section 123 shown in FIG. 2 sequentially loads display data for one line supplied from the outside of the gradation voltage generating section 110, and the display data latching section 112 retains the display data for each data line in each row (display pixel PX). The display data D/A converter generates a gradation voltage Vdata having a value corresponding to the display data and outputs the gradation voltage Vdata to the voltage adding section 130.

On the other hand, the voltage based on the detected voltage Vdec temporarily retained in the capacitance C1 for retaining electric charges of the voltage retaining section 120 is output as a reference voltage Vref to the voltage adding section 130 by the buffer circuit of the voltage retaining section 120. The reference voltage Vref obtains a value equivalent to the detected voltage Vdec (=Vst≈Va) detected in the voltage detecting operation.

As a result, in the voltage adding section 130, the gradation voltage Vdata supplied from the gradation voltage generating section 110, the reference voltage Vref supplied from the voltage retaining section 120 and the intrinsic voltage Vref0 determined based on the design parameter of the thin film transistor Tr13 provided to the display pixel PX (driving circuit DC) are added and subtracted so that a negative-polar pixel data voltage Vpix having a predetermined value (Vref−Vref0+Vdata) is generated and is applied to the data line DL.

In the case where a design threshold voltage of the thin film transistor Tr13 is denoted by Vth0 and a gate-source voltage (=drain-source voltage), which is generated when the constant current Iref is applied to the electric current path between the drain and the source of the thin film transistor Tr13 where the gate and the drain are connected, is denoted by Vgt, the intrinsic voltage Vref0 is a voltage expressed by Vref0=Vgt−Vth0. This voltage practically corresponds to the gate-source voltage (=drain-source voltage) generated at the time of applying the constant current Iref to the electric current path of the thin film transistor Tr13 when the threshold voltage Vth of the thin film transistor Tr13 is assumed to be 0V. The values Vgt and Vth0 are predetermined based on the design parameter of the thin film transistor Tr13.

Therefore, the voltage component (Vref−Vref0) corresponding to the difference between the reference voltage Vref and the intrinsic voltage Vref0 in the pixel data voltage Vpix (=Vref−Vref0×Vdata) generated by the voltage adding section 130 corresponds to the difference between volt-ampere characteristic lines of the thin film transistors with different threshold voltages as shown in FIG. because the reference voltage Vref (=Vdec) is the gate-source voltage (voltage between the drain and source terminals) Vst (≈Va) generated at the time of applying the constant current Iref to the electric current path between the drain and the source of the thin film transistor Tr13. This voltage component corresponds to the threshold voltage Vth of the thin film transistors. In the electric current setting operation and the voltage detecting operation, the voltage of the data line DL (voltage generated at the source terminal of the thin film transistor Tr13) is detected as the detected voltage Vdec, and this is equivalent to the threshold voltage Vth of the thin film transistor Tr13 (driving transistor) being detected (monitored).

When the pixel data voltage Vpix is applied directly to the source terminal of the thin film transistor Tr13 provided in the display pixel PX (driving circuit DC) via the data line DL, capacitor Cs between the gate and the source of the thin film transistor Tr13 is charged with the voltage component Vc (≈Vref−Vref0+Vdata=Vth+Vdata) according to the pixel data voltage Vpix.

In the pixel data-writing operation, the time constant at the time of charging (writing) between the gate and the source (capacitor Cs) of the thin film transistor Tr13 with the voltage component corresponding to the pixel data voltage Vpix can be expressed by C×R. C denotes a capacity component (wiring capacity) which is parasitic on a wiring path to which the pixel data voltage Vpix is applied, and P denotes a resistance component (wiring resistance) of the wiring path.

For example, when the wiring resistance is set to 10 kΩ and the wiring capacity is set to 20 pF, the time constant C×R is calculated in such a manner that 10 kΩ×20 pF=200 nsec. For this reason, even when the pixel data-writing period is set to a very short time, for example, 5 μsec, the display data (pixel data voltage Vpix) can be sufficiently written. Therefore, the total time of the electric current setting period Tset and the pixel data-writing operation Twrt can be set within 50+5=55 μsec.

When the capacitor Cs between the gate and the source of the thin film transistor Tr13 provided in the display pixel PX (driving circuit DC) is charged with the voltage component (Vc≈Vpix=Vth+Vdata) corresponding to the pixel data voltage Vpix, the thin film transistor Tr13 is operated in a conduction state based on the voltage component (corresponding to the gradation voltage Vdata) not less than the threshold voltage Vth in the voltage component. For this reason, as shown in FIG. 8, a writing current Iwrt is applied from the power supply line VL in a direction of the display driving device 100A (voltage adding section 130) via the thin film transistor Tr13, the contact point N12, the thin film transistor Tr12 and the data line DL.

At the pixel data-writing period Twrt, a driving current is not applied to the organic EL element OEL, and thus the light emitting operation is not performed.

(Light Emitting Operation)

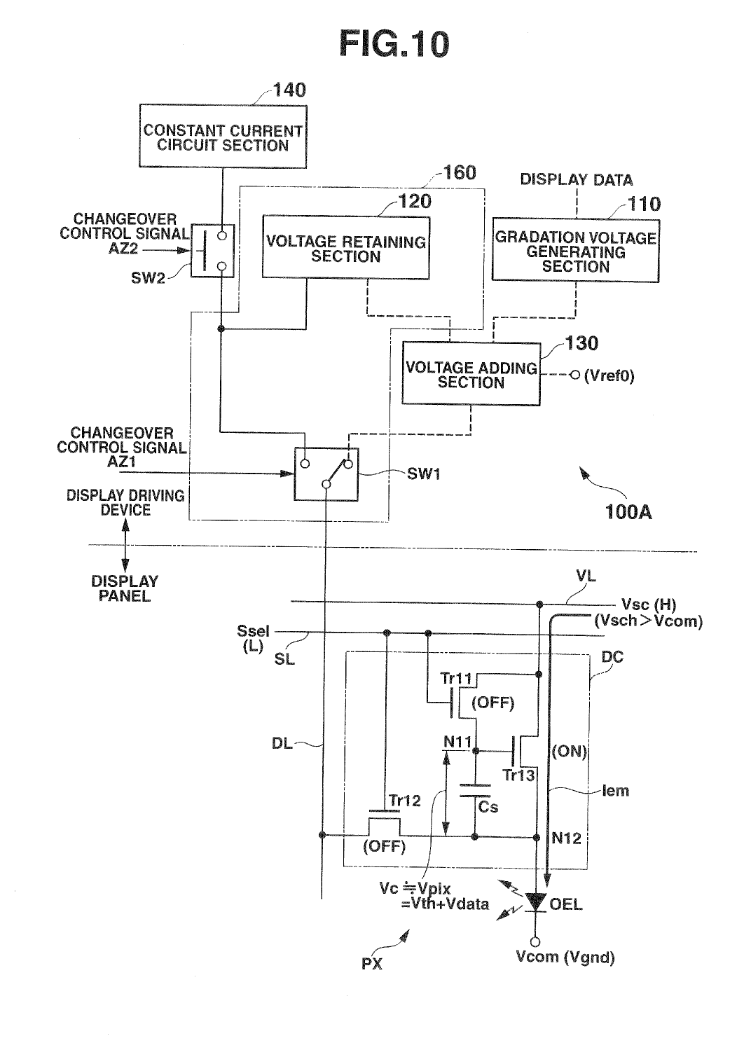

FIG. 10 is a conceptual diagram illustrating the light emitting operation in the display device (display driving device and display pixel) according to the first embodiment.

At a light emitting period Tem, as shown in FIG. 4, a selection signal Ssel of off level (low level; L) is applied to the selection line SL, and a supply voltage Vsc (=Vsch) of high potential (H) is applied to the power supply line VL. In synchronization with this timing, the operation for applying the pixel data voltage Vpix by means of the display driving device 100A is stopped.

The supply voltage Vsc (=Vsch) of high potential is set so as to obtain a value (a positive voltage to be a forward bias with respect to a voltage Vcom connected to the cathode of the organic EL element GEL) which is not less than an anode voltage necessary at the time of allowing the organic EL element OEL to emit light with maximum luminance gradation.

As a result, the thin film transistors Tr11 and Tr12 provided to the driving circuit DC composing the display pixel PX into which the pixel data voltage is written are turned off (namely, the display pixel PX is set into an unselected state), and the application of the supply voltage Vsc to the gate terminal (the contact point N11; one end of the capacitor Cs) of the thin film transistor Tr13 is cut off, and at the same time, the electric connection between the data line DL and the source terminal of the thin film transistor Tr13 (the contact point N12; the other end of the capacitor Cs) is cut off. For this reason, the voltage component (Vc Vpix=Vth+Vdata) with which the capacitor Cs between the gate and the source of the thin film transistor Tr13 is charged in the pixel data-writing period Twrt is retained, so that the thin film transistor is maintained in the on state.

Therefore, as shown in FIG. 10, a driving current Iem (=Idata) having a value according to the voltage component (gradation voltage Vdata) to be not less than the threshold voltage Vth in the voltage component with which the capacitor Cs between the gate and the source of the thin film transistor Tr13 is charged is applied from the power supply line VL in the direction of the organic EL element OEL via the thin film transistor Tr13 and the contact point N12. The organic EL element OEL continuously emits light with a luminance gradation corresponding to the display data (gradation voltage Vdata).

According to the display device (display driving device and display pixel) according to the first embodiment, prior to the writing operation for pixel data voltage corresponding to the display data (pixel data-writing period Twrt), at the display driving period Tcyc, the voltage component (detected voltage Vdec) corresponding to (or closely related with) the threshold voltage Vth of the thin film transistor Tr13 as the driving transistor is detected and is temporarily retained, the pixel data voltage Vpix, which is obtained by combining the voltage component (Vref−Vdef0) corresponding to the threshold voltage Vth calculated by using the reference voltage Vref corresponding to the detected voltage Vdec and the intrinsic voltage Vref0 determined based on the design parameter of the thin film transistor Tr13 at the pixel data-writing period Twrt, with the gradation voltage Vdata corresponding to the display data, is applied to the display pixel PX, at the pixel data-writing period Twrt and the capacitor Cs between the gate and the source of the thin film transistor Tr13 can be charged (retained) simultaneously with the voltage component corresponding to the gradation voltage Vdata and the voltage component (Vref−Vref0) corresponding to the threshold voltage Vth.

In this case, the voltage component corresponding to the threshold voltage Vth of the thin film transistor Tr13 provided to each display pixel PX at a current time point (detecting time point) can be detected by the electric current setting operation and the voltage detecting operation executed prior to the pixel data-writing operation. For this reason, even if the threshold voltage Vth of the thin film transistor Tr13 fluctuates (threshold shift), the pixel data voltage Vpix including the voltage component (Vref−Vref0) corresponding to the fluctuation amount can be generated in real time (namely, the threshold shift can be compensated), and the driving current Iem having a value corresponding to the display data is supplied to the organic EL element OEL so that it can be allowed to emit light with suitable luminance gradation.

At determination of Vref0, a voltage drop in the thin film transistor Tr12 and another voltage droop due to wiring resistance component are omitted, but these values are roughly determined based on the design parameter of the driving circuit DC in advance similarly to the values Vgt and Vth0. Therefore, it is desirable that the value Vref0 is desirably determined in consideration of the influences of these values

According to the circuit configuration of the display pixel (driving circuit DC) applied to the first embodiment, the single driving transistor (thin film transistor Tr13) is controlled to be driven so that the voltage component (pixel data voltage) corresponding to the display data is retained between the gate and the source of the single driving transistor in the selected state of the display pixel, and the driving current Iem having a predetermined value based on the retained voltage component is supplied to the organic EL element OEL in the unselected state. For this reason, the influences of the dispersion of the element properties between the thin film transistors and the time change can be suppressed, and even when amorphous silicon thin film transistors are adopted as the thin film transistors, the threshold shift can be compensated in real time, so that uniform display image quality (light emitting property) can be realized stably for a long time.

The description of the display device driving method refers to the case where, prior to the display data (pixel data voltage Vpix) writing operation and the light emitting operation, the electric current setting operation and the voltage detecting operation for detecting the voltage component Vts (=Vdec) corresponding to the threshold voltage Vth of the driving transistor (thin film transistor Tr13) are executed in each display driving period (one processing period) Tcyc on the display pixel PX of each line of the display panel.

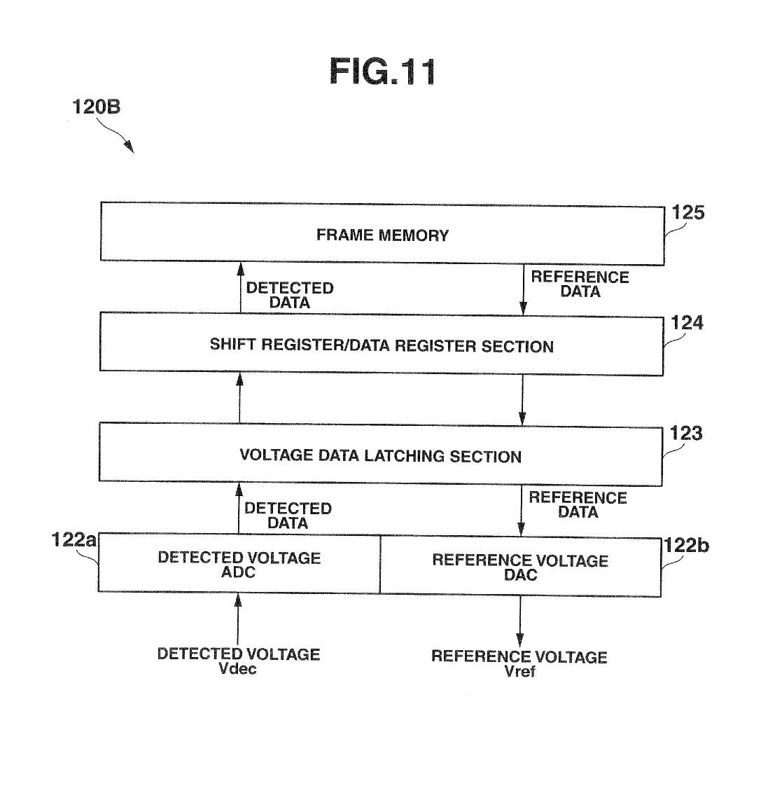

However, the present invention is not limited to this, and for example, a memory section which stores a detected voltage component or its corresponding voltage is provided, and the electric current setting operation and the voltage detecting operation may be executed intermittently, i.e., every several processing periods. In another manner, these operations may be executed at any timing, such as the time of actuating the display device. As a result, since the electric current setting operation and the voltage detecting operation do not have to be executed in every display driving period Tcyc, the pixel data-writing period Twrt and the light emitting period Tem can be set relatively longer. FIG. 11 is a schematic block diagram illustrating a constitutional example having the memory section for performing the above operations as another constitutional example of the voltage retaining section applied to the display device of the first embodiment.

The voltage retaining section 120B in FIG. 11 includes a detected voltage analog-digital converter (hereinafter, “detected voltage A/D converter”, and in the drawing, “detected voltage ADC” for convenience) 122a, a reference voltage digital-analog converter (hereinafter, “reference voltage D/A converter”, and in the drawing, “reference DAC” for convenience) 121b, a voltage data latching section 123, a shift register/data register section 124, and a frame memory (memory section) 125. The detected voltage AD converter 122a loads a voltage generated on the data line DL at the time of the electric current setting operation as a detected voltage Vdec, and converts it into detected data composed of a digital signal voltage. The voltage data latching section 123 selectively performs an operation for loading and retaining the detected data converted by the detected voltage A/D converter 122a per display pixel PX for one line or an operation for loading and retaining reference data transmitted via the shift register/data register section 124 per display pixel PX The shift register/data register section 124 has a shift register and a data register similarly to the shift register/data register section 111 provided to the gradation voltage generating section 110. The shift register/data register section 124 selectively performs an operation for loading the detected data retained per display pixel PX in the voltage data latching section 123 and transmitting it to the frame memory 125, or an operation for loading reference data of the display pixel PX for a specific one line from the frame memory 125 and transmitting it to the voltage data latching section 123.

In the first embodiment, the shift register/data register section 111 provided to the gradation voltage generating section 110 and the shift register/data register section 123 provided to the voltage retaining section 120B are constituted individually, but in any constitutions, they perform an operation for sequentially loading serial data and transmitting them collectively as parallel data or an operation for loading parallel data collectively and sequentially transmitting them as serial data. For this reason, a single shift register/data register section may be commonly applied to these constitutions. Prior to the operation for writing the display data (luminance gradation data) into the display pixels PX arranged on the display panel, the frame memory 125 sequentially loads detected data based on the detected voltage Vdec detected per display pixel PX for one line by the detected voltage A/D converter 121a via the shift register/data register section 123. The frame memory 125 stores the detected data individually per display pixel PX on one screen (frame) of the display panel, and sequentially outputs the detected data as reference data via the shift register/data register section 124 so as to transmit them to the voltage data latching section 123. The reference voltage D/A converter 122b converts the reference data composed of a digital signal voltage of each display pixel PX retained in the voltage data latching section 122 into a reference voltage Vref composed of an analog signal voltage at the time of the pixel data-writing operation so as to output it to the voltage adding section 130.

In the above constitution, at the time of the operation for writing the display data into each display pixel PX, the reference voltage Vref, the intrinsic voltage Vref0 of the driving transistor, and the gradation voltage Vdata are added/subtracted so that the pixel data voltage Vpix is generated. However, the present invention is not limited to this, and for example, when the detected data corresponding to the detected voltage Vdec is stored in the frame memory 124, digital data (threshold data) corresponding to the threshold voltage Vth (=Vdec−Vref0=Vref−Vref0), which is obtained by subtracting the predetermined intrinsic voltage Vref0 of the driving transistor (thin film transistor Tr13) from the detected voltage Vdec, may be stored. In this case, the threshold voltage Vth (=Vref−Vref0) is generated based on the digital data (threshold data) read from the frame memory 124, and the voltage adding section 130 adds the threshold voltage Vth and the gradation voltage Vdata so as to generate the pixel data voltage Vpix.

### Second Embodiment

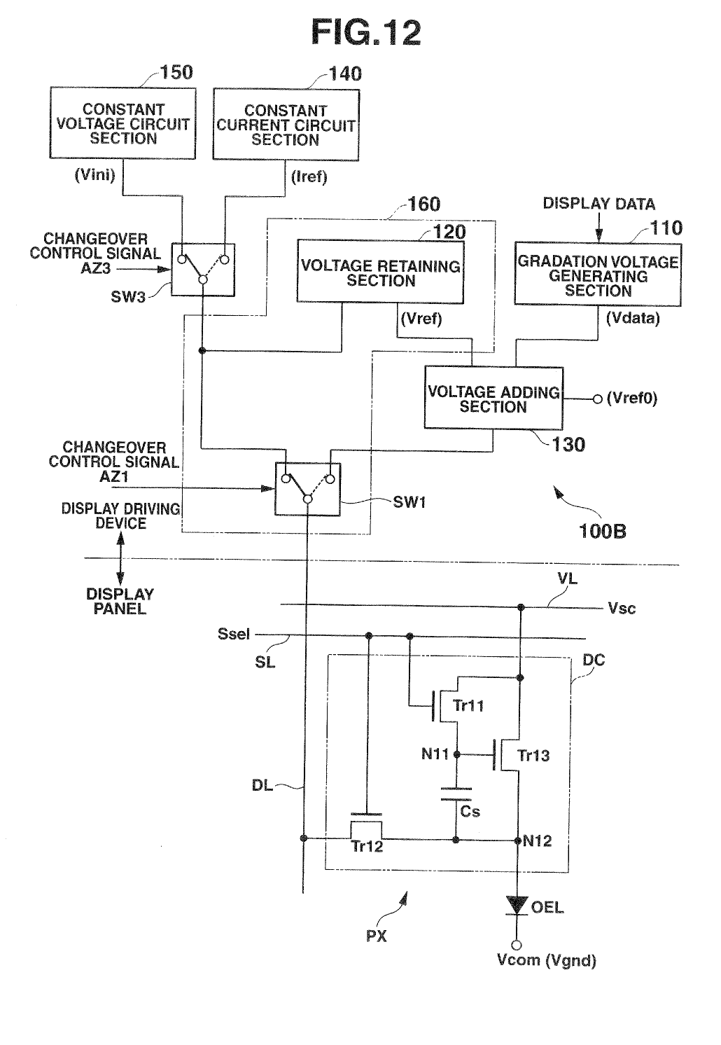

FIG. 12 is a main section constitutional diagram illustrating the display section according to a second embodiment of the present invention. The constitution equivalent to that of the display device described in the first embodiment is designated by the equivalent or same reference numerals, and the description thereof is simplified.

(Display Driving Device)

As shown in FIG. 12, in addition to the constitution (see FIG. 1) of the display driving device 100A according to the first embodiment, a display driving device (data driving section) 100B according to the second embodiment has a constant voltage circuit section (constant voltage supplying section) 150 which applies a constant voltage Vini having a predetermined value to the display pixel PX via the data line DL of the display panel, and a changeover switch SW3 which selectively switches over a connected state between the data line DL and the constant current circuit section 140 or the constant voltage circuit section 150 instead of the changeover switch SW2.

The constant voltage circuit section 150 applies a constant voltage Vini having a predetermined value (negative polarity) to the data line DL, so that the voltage component corresponding to the constant voltage Vini is retained at the source terminal (specifically, between the gate and the source) of the driving transistor provided to the display pixel. In the second embodiment, the constant voltage Vini is set so as to have a value (negative polarity) which is sufficiently lower than the supply voltage Vsc (=Vscl) of the low potential (L) applied to the power supply line VL.

The changeover switch SW3 selectively connects the data line DL connected via the changeover switch SW1 to the constant current circuit section 140 or the constant voltage circuit section 150 based on a changeover control signal AZ3 supplied from the system controller, not shown. That is, at the time of the voltage setting operation (described in detail later) for applying the constant voltage Vini to the display pixel PX via the data line DL, the switching is controlled so that the data line DL is connected to the constant voltage circuit section 150, and at the electric current setting operation for supplying the constant current Iref to the display pixel PX after the voltage setting operation, the switching is controlled so that the data line DL, is connected to the constant current circuit section 140.

The changeover switch SW1 controls to switch into the changeover switch SW3 at the voltage setting operation, the electric current setting operation and the voltage detecting operation, and controls to switch into the voltage adding section 130 at the time of the pixel data-writing operation based on the changeover control signal AZI.

(Driving Method)

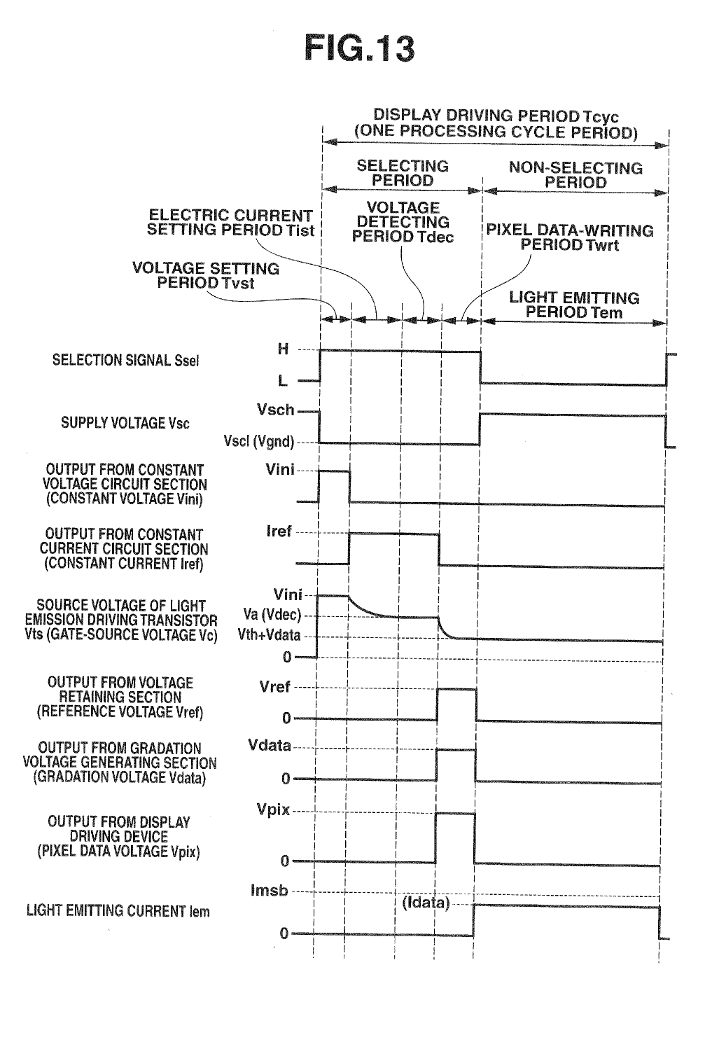

FIG. 13 is a timing chart illustrating one example of the driving method in the display device (display driving device and display pixel) according to the second embodiment. Descriptions on operations equivalent to the driving method according to the first embodiment are simplified.

As shown in FIG. 13, the driving control operation in the display device having the display driving device 100B having the above constitution roughly includes: a voltage setting operation (voltage setting period Tvst) for applying the constant voltage Vini to the display pixel PX (driving circuit DC); an electric current setting operation (corresponding to the electric current setting period Tist; the electric current setting period Tset in the first embodiment) for supplying the constant current Iref to the display pixel PX (driving circuit DC); a voltage detecting operation (voltage detecting period Tdec) for detecting and retaining a voltage Vts (voltage of data line DL) generated at the source terminal of the driving thin film transistor Tr13 provided to the display pixel PX; and a pixel data-writing operation (pixel data-writing period Twrt) for writing pixel data voltage Vpix (=Vref−Vref0+Vdata) corresponding to the display data and the threshold voltage Vth of the thin film transistor TR13 into the display pixel PX at the selected period in the display driving period (one-process cycle period) Tcyc. The driving control operation includes a light emitting operation (light emitting period Tem) for applying a driving current corresponding to the display data to the organic EL element OEL so as to allow the organic EL element OEL to emit light with desired luminance gradation at the unselected period in the display driving period Tcyc (Tcyc≧Tvst+Tist+Tdec+Twrt+Tem)

The respective control operations are described below. The control operations specific to the second embodiment are described in detail.

(Voltage Setting Operation)

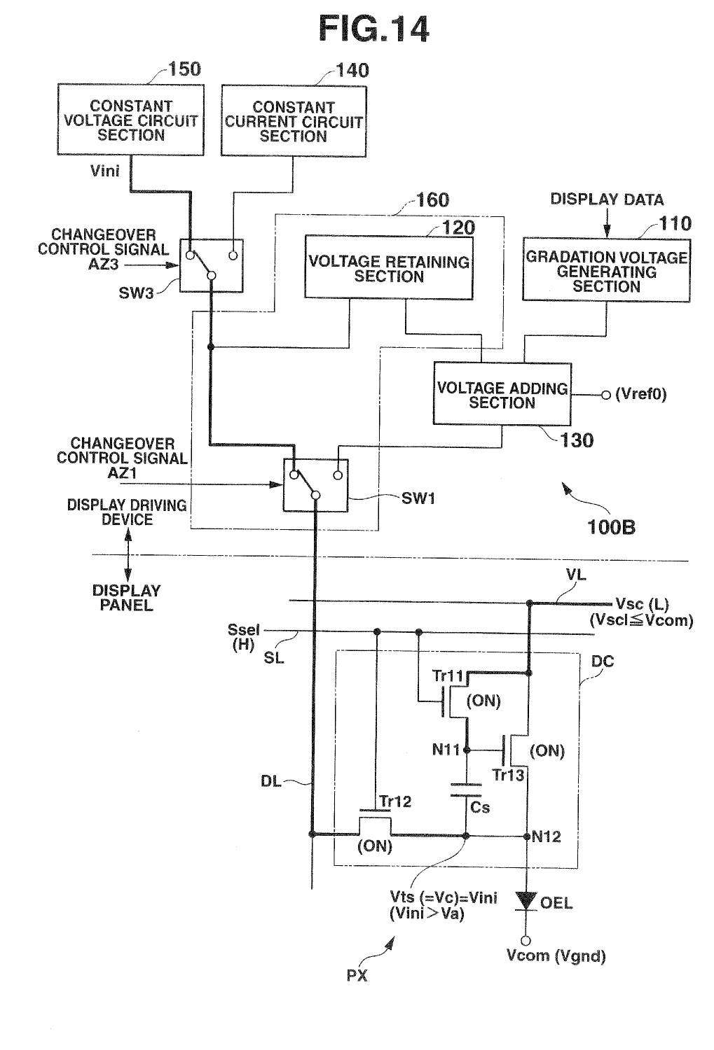

FIG. 14 is a conceptual diagram illustrating the voltage setting operation in the display device (display driving device and display pixel) according to the second embodiment.

As shown in FIG. 14, at the voltage setting period Tvst, the on-level selection signal Ssel is applied to the selection line SL, and the changeover switch SW1 is switched into the change over switch SW3 with the supply voltage Vsc (=Vscl) of low potential (L) being applied to the power supply line VL based on the changeover control signals AZ1 and AZ3. Further, when the changeover switch SW3 is switched into the constant voltage circuit section 150 as shown in FIG. 14, the constant voltage Vini output from the constant voltage circuit section 150 is applied to the data line DL via the changeover switches SW3 and SW1

As a result, the thin film transistors Tr11 and Tr12 provided to the display pixel PX (driving circuit DC) are turned on (namely, the display pixel PX is set into the selected state), so that the supply voltage Vsc (=Vscl=Vgnd) is applied to the gate terminal (contact point N11 as one end of the capacitor Cs) of the thin film transistor Tr13 via the thin film transistor Tr11, and the constant voltage Vini applied from the constant voltage circuit section 150 to the data line DL is applied to the source terminal (contact point N12 as the other end of the capacitor Cs) of the thin film transistor Tr13 via the thin film transistor Tr12.

In this voltage setting operation (voltage setting period Tvst), the constant voltage Vini applied from the constant voltage circuit 150 to the data line DL is set so as to have a negative value (negative polarity). Further, in the electric current setting operation, when the constant current Iref is supplied to the display pixel PX by the constant current circuit section 140, the constant voltage Vini is preferably set so as to be higher than a voltage Vts (=Va>Vth) retained at the source terminal (between the gate and the source) of the driving transistor (thin film transistor Tr13) provided to the display pixel PX (Vini>Va).

The constant voltage Vini having a value sufficiently higher than the threshold voltage Vth of the thin film transistor Tr13 provided to the driving circuit DC is applied to the source terminal (contact point N12) of the thin film transistor Tr13, so that the voltage component Vts (=Vini) corresponding to the voltage Vini is retained between the gate and the source (namely, capacitor Cs) of the thin film transistor Tr13 for a very short time.

At this voltage setting period Tvst, electric charges of the voltage component corresponding to the constant voltage Vini are accumulated in the capacitor Cs provided between the gate and the source of the thin film transistor Tr13, and also the electric charges corresponding to the constant voltage Vini are accumulated in another capacity component parasitic to the wiring path passing from the display driving device 100B to the display pixel PX (driving circuit DC).

(Electric Current Setting Operation)

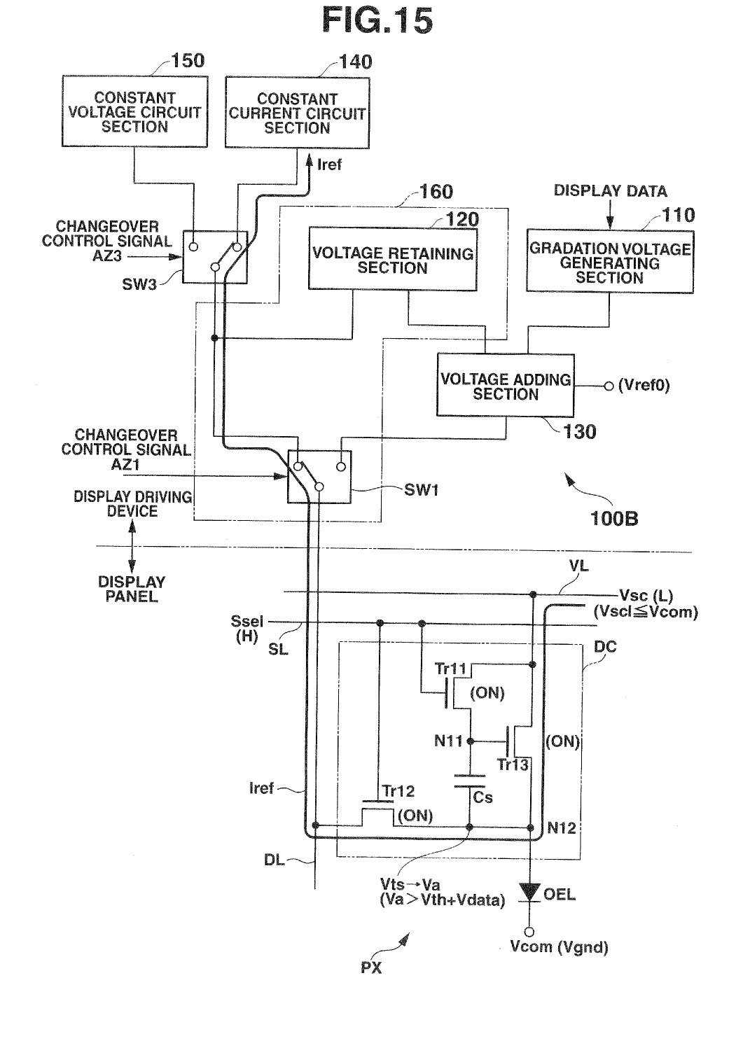

FIG. 15 is a conceptual diagram illustrating the electric current setting operation in the display device (display driving device and display pixel) according to the second embodiment.

Similarly to the first embodiment, in the electric current setting period Tist (current setting operation), in the state that the on-level selection signal Ssel is applied to the selection line SL, and the supply voltage Vsc (=Vscl) of low potential (L) is applied to the power supply line VL, the changeover switch SW3 is switched into the constant current circuit section 140 based on the changeover control signals AZ1 and AZ3, so that the constant current Iref having a negative value (negative polarity) output from the constant current circuit section 140 is supplied to the data line DL via the changeover switches SW3 and SW1 as shown in FIG. 15.

As a result, the constant current Iref is applied from the power supply line VL to which the supply voltage Vsc (=Vscl=Vgnd) of low potential (L) is applied in the direction of the constant current circuit section 140 via the thin film transistors Tr13 and Tr12 and the data line DL, and the voltage component corresponding to the constant current Iref is retained between the gate and the source (capacitor Cs) of the thin film transistor Tr13.

At this time, since the voltage component corresponding to the constant voltage Vini is already retained between the gate and the source of the thin film transistor Tr13 by the voltage setting operation, some of the electric charges retained between the gate and the source are discharged by the electric current setting operation, and the constant voltage Vini is changed so as to be converged to the gate-source voltage at the time of applying the constant current Iref to the electric current path (between the drain and the source) of the thin film transistor Tr13 (Vini→Va).

The constant current Iref is set so as to have a value for enabling the voltage (Va>Vth) larger than the voltage value obtained by adding the threshold voltage Vth of the thin film transistor Tr13 and the gradation voltage Vdata generated based on the display data to be generated between the drain and source terminals (contact point N12) of the thin film transistor Tr13. For this reason, the voltage component Vini retained between the gate and the source of the thin film transistor Tr13 can be converged to the voltage component Va corresponding to the constant current Iref by the voltage setting operation.

(Voltage detecting Operation, Pixel Data-Writing Operation and Light emitting Operation)

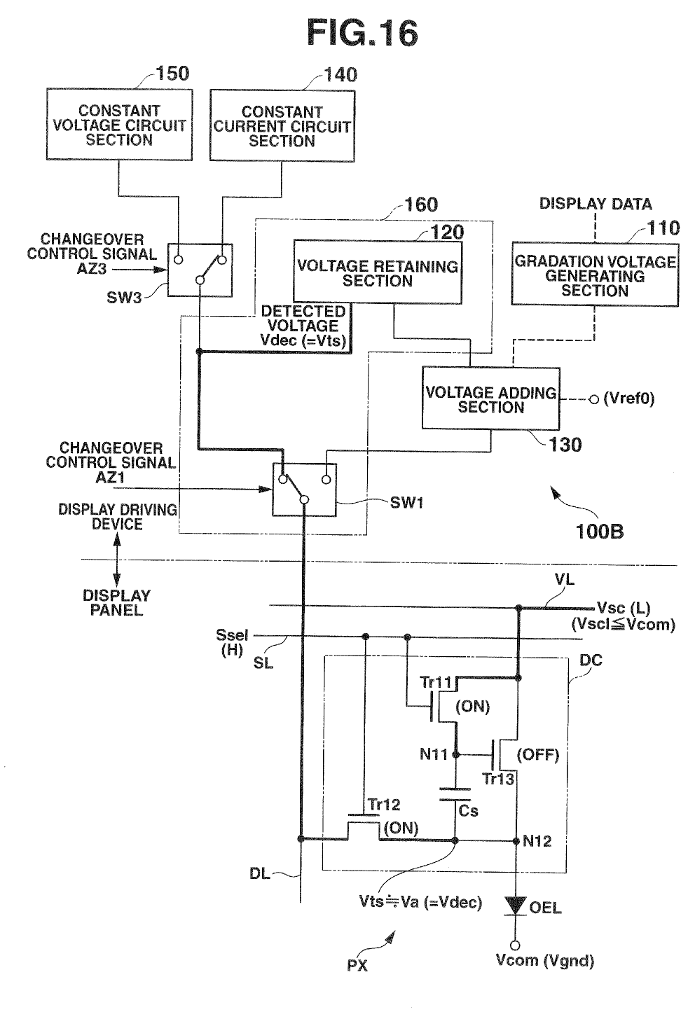

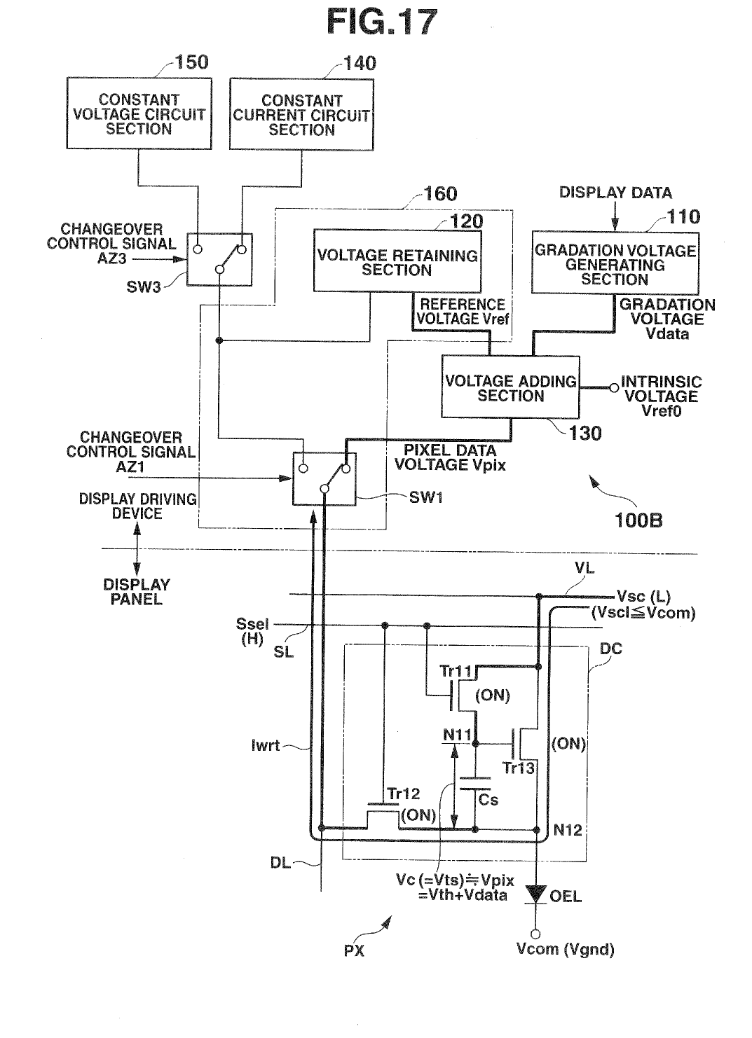

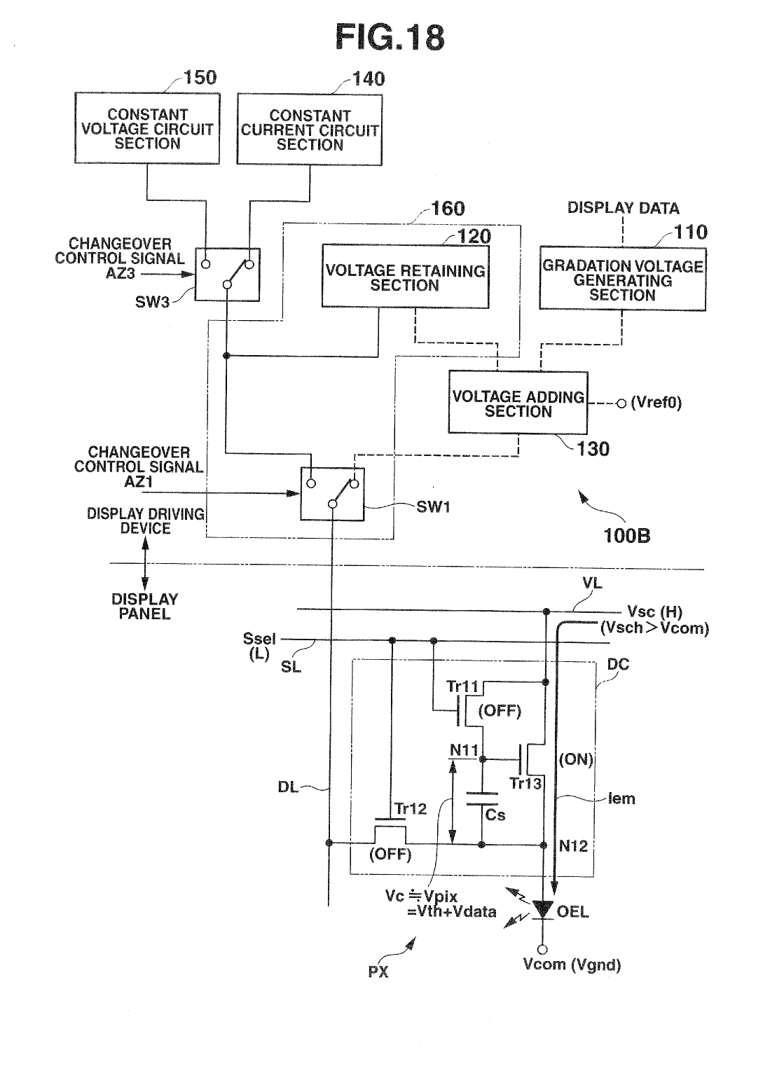

FIG. 16 is a conceptual diagram illustrating the voltage detecting operation in the display device (display driving device and display pixel) according to the second embodiment. FIG. 17 is a conceptual diagram illustrating the pixel data-writing operation in the display device (display driving device and display pixel) according to the second embodiment. FIG. 18 is a conceptual diagram illustrating the light emitting operation in the display device (display driving device and display pixel) according to the second embodiment. Since the voltage detecting operation, the pixel data-writing operation and the light emitting operation in the second embodiment are basically equivalent to those in the first embodiment, the description thereof is simplified.

Similarly to the first embodiment, at the voltage detecting period Tdec (voltage detecting operation), after the voltage Vts generated at the source terminal (between the drain and source terminals) of the thin film transistor Tr13 in the electric current setting operation is converged, as shown in FIG. 16, the voltage detecting section 160 having the voltage retaining section 120 electrically connected to the data line DL via the changeover switch SW1 detects a voltage of the data line DL (namely, a source voltage Vts of the thin film transistor Tr13 provided to the display pixel PX) as the detected voltage Vdec, and temporarily retains the detected voltage Vdec in the capacitance C1 for retaining electric charges in the voltage retaining section 120.

At the pixel data-writing period Twrt, as shown in FIG. 17, the changeover switch SW1 is switched into the voltage adding section 130, and the pixel data voltage Vpixe (=Vth+Vdata=Vref−Vref0+Vdata) corresponding to the display data and the threshold voltage Vth of the thin film transistor Tr13 is applied from the voltage adding section 130 to the display pixel PX via the data line DL, so that between the gate and source terminals (capacitor Cs) of the thin film transistor Tr13 provided to the driving circuit DC can be charged with the voltage component corresponding to the pixel data voltage Vpix.

At the light emitting operation Tem, as shown in FIG. 13, the selection signal Ssel is applied to the selection line SL, and the supply voltage Vsc (=Vsch) of high level (H) is applied to the power supply line. As a result, the thin film transistors Tr11 and Tr12 provided to the display pixel PX (driving circuit DC) are turned off (namely, the display pixel PX is set into the unselected state), the application of the supply voltage Vsc (=Vsch) to the gate terminal (contact point N11; one end of the capacitor Cs) of the thin film transistor Tr13 is cut off, and the application of the pixel data voltage Vpix to the source terminal (contact point N12; the other end of the capacitor Cs) is cut off. For this reason, the voltage component (Vth+Vdata) charged between the gate and the source (capacitor Cs) is retained at the pixel data-writing period Twrt.

As a result, the thin film transistor Tr13 is maintained in the on state, and as shown in FIG. 18, the driving current Iem corresponding to the gradation voltage Vdata is applied from the power supply line VL in the direction of the organic EL element OEL via the thin film transistor Tr13 and the contact point N12, so that the organic EL element OEL continuously emits light with a luminance gradation corresponding to the display data (gradation voltage Vdata).

According to the display device (display driving device and display pixel) in the second embodiment, prior to the display data (pixel data voltage Vpix) writing operation, the voltage setting operation and the electric current setting operation are performed, so that the voltage component corresponding to the constant voltage Vini having a relatively large value is instantaneously retained at the source terminal of the driving transistor (thin film transistor Tr13). Thereafter, the voltage component can be converged to the voltage value Va based on the constant current Iref for a relatively short time.

When only the electric current setting operation is used to charge between the gate and the source of the driving transistor with a predetermined voltage component Va, and for example, when the voltage component Va fluctuates (threshold shift) in a direction where the threshold voltage Vth of the driving transistor (thin film transistor Tr13) becomes large, the time constant at the time of retaining the voltage component becomes large based on the constant current Ire. The time required for saturating (converging) the source voltage by means of the electric current setting operation becomes longer, and thus the display data (pixel data voltage Vpix) writing operation period possibly becomes relatively short.

On the contrary, according to the driving method of the second embodiment, when the voltage setting operation is performed prior to the electric current setting operation, the charging with the voltage component Vini (>Va) having a larger value than the voltage component Va charged based on the constant current Iref in the electric current setting operation can be carried out regardless of (the fluctuation of) the threshold voltage Vth of the driving transistor. For this reason, the driving transistor is turned on and the electric current can be applied at the initial time point of the electric current setting operation. As a result, since the voltage component Vini can shift to Va for a relatively short time, the time required for the voltage setting operation, the electric current setting operation and the voltage detecting operation can be relatively shortened, and the display data-writing period and the light emitting period can be set to be relatively longer.

An effect of the voltage setting operation is verified in detail.

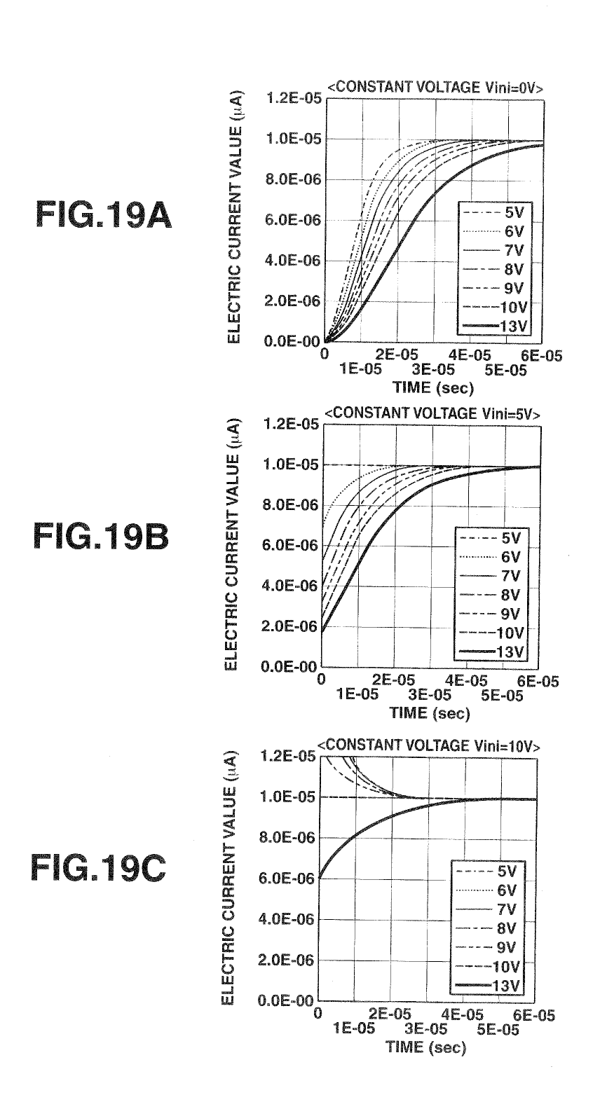

FIGS. 19A, 19B and 19C illustrate simulation results illustrating a relationship between the value of the constant voltage in the voltage setting operation and the time change of the constant current in the electric current setting operation according to the second embodiment. FIGS. 19A, 19B and 19C illustrate the time change (converged state) of the constant current Iref in the case where the constant voltage Vini is set to 0V, 5V and 10V and the threshold voltage of the thin film transistor is changed (5 to 13V).

In the first embodiment, when the threshold voltage of the driving transistor (thin film transistor Tr13) exhibits a large fluctuation, the time constant at the time of retaining the predetermined voltage component Va between the gate and the source of the transistor by means of the constant current Iref becomes large in proportion to the threshold voltage Vth in the electric current setting operation.

That is, since the time constant is expressed by Ctl×V/Id in the equivalent circuit shown in FIG. 6, as described in the first embodiment, when the electrostatic capacity of the capacity element Ct1 is set to 18 pF, the value of the electric current Id (constant current Iref) applied to the transistor element TrA is set to 5 μA, and the intrinsic voltage Vref0 determined based on the design parameter of the transistor element TrA is set to 3V and the threshold voltage of the transistor element TrA is changed into 10V by the threshold value shift, the time constant is calculated in such a manner that 18 pF×(10+3)V/5 μA=46.8 μsec.

When the electric current setting period Tset is set to 50 μse, the percentage of the writing into the driving transistor (thin film transistor Tr13) by the supply of the constant current Iref becomes 62%, and the voltage Va written by the electric current setting operation rapidly changes.

As described in the second embodiment, prior to the electric current setting operation, the voltage setting operation is performed and the constant voltage Vini, (>Va) is applied, so that the voltage component corresponding to the constant voltage Vini is retained between the gate and the source of the driving transistor (thin film transistor Tr13). As a result, in the following electric current setting operation, the time constant at the time of supplying the constant current Iref can be reduced.

Specifically, when the constant voltage Vini is applied from the constant current circuit section 150 by the voltage setting operation, the voltage components of 0V, 5V and 10V are retained between the gate and the source of the thin film transistor Tr13 provided to the display pixel PX (driving circuit DC). In this case, when the change in the value of the constant current Iref with respect to time is verified for each threshold voltage of the thin film transistor Tr13, as shown in FIG. 19A, it is found that the threshold voltage Vth of the thin film transistor Tr13 increases in the case of the constant current Vini of 0V, and accordingly the time required for saturation (convergence) of the value of the constant current Iref becomes long.

On the contrary, as shown in FIGS. 19B and 19C, in the case where the constant voltage Vini is set to be high (Vini=5V and 10V), it is found that the time required for saturation (convergence) of the value of the constant current Iref becomes short. For example, as shown in FIG. 19C, in the case where the constant voltage Vini is set to 10V, the time required for saturation of the constant current Iref at the time when the threshold voltage Vth of the thin film transistor Tr13 is 10V is roughly 30 μsec or less based on the writing percentage of 98%. As shown in FIG. 19A, in the case where the constant voltage Vini is 0V, the time required for saturation of the constant current Iref is roughly 60 μsec or more, but the electric current can be written for about half of the time.

Therefore, in the voltage setting operation, as the value of the constant voltage Vini applied to the source terminal of the driving transistor (thin film transistor Tr13) is set to be higher, the voltage component (the amount of electric charges) retained between the gate and the source (capacitor Cs) of the driving transistor can be larger. For this reason, the time required for the following electric current setting operation can be shortened.

The above embodiments describe the case where the circuit configuration composed of the three thin film transistors Tr11 to Tr13 is applied as the driving circuit DC provided to the display pixel PX as shown in FIG. 1, but the present invention is not limited to this. That is, the present invention may have another circuit configuration as long as at the time of the display data (pixel data voltage) writing operation (selected) on the display pixel, in a state that the gate and the drain of the single driving transistor (thin film transistor Tr13) is short-circuited so as to have the same electric potential, the voltage component corresponding to the display data is retained between the gate and the source, and the light emitting element (organic EL element OEL) is set into a non-light emitting state without supplying an electric current thereto, whereas at the time of the display pixel light emitting operation (unselected), the driving current having a predetermined value based on the voltage component retained between the gate and the source is supplied to the light emitting element and allows it to emit light.

Further, the embodiments do not particularly describe the relationship between the display panel on which the display pixels are arranged and the display driving device, and for example, the display driving device of a driver chip form may be mounted and connected onto a panel substrate composing the display panel, or a thin film technique may be applied to the panel substrate, and the display driving device as well as the display pixel (driving circuit) may be formed integrally.

<Display Device>

An entire constitution of the display device having the display driving device and the display pixel described in the embodiments will be described simply.

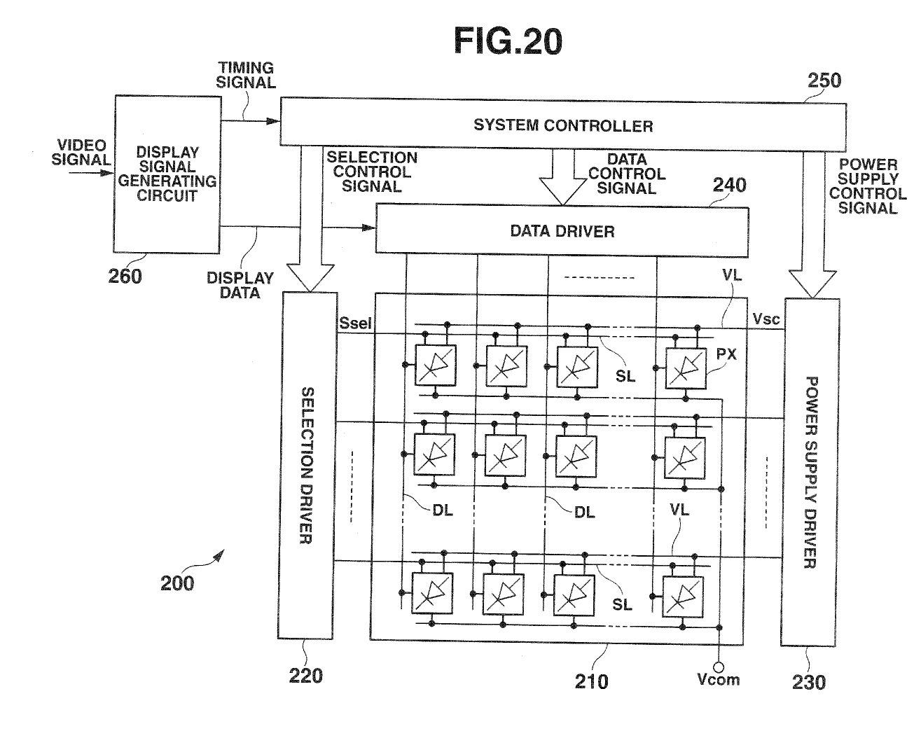

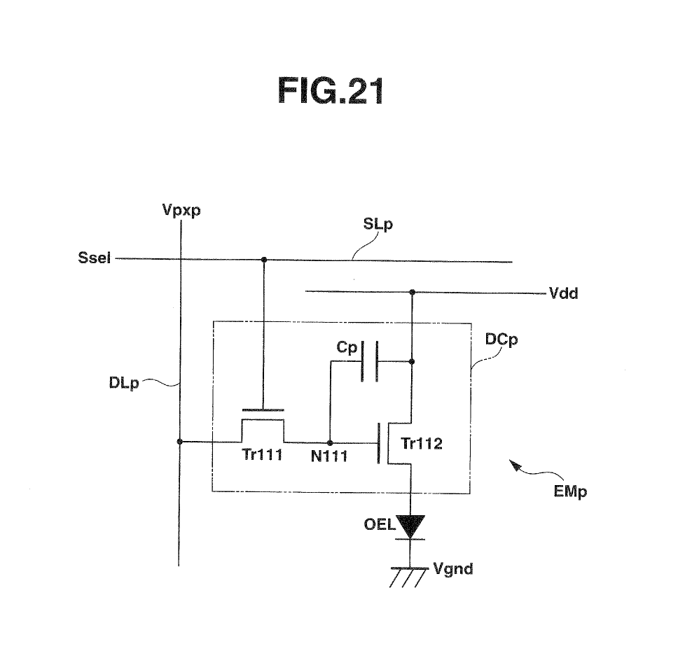

FIG. 20 is a schematic constitutional diagram illustrating one example of the entire constitution of the display device according to the present invention. The constitutions equivalent to the display driving device and the display pixel (driving circuit) are denoted by the equivalent symbols and described with reference to the drawings.

As shown in FIG. 20, a display device 200 of the present invention is constituted so as to basically include: a display panel 210 where a plurality of display pixels PX having the driving circuit DC and the organic EL element (light emitting element) OEL having the circuit configuration (see FIG. 1) equivalent to the embodiments is arranged two-dimensionally (arranged into a matrix pattern) near each intersecting point between a plurality of selection lines SL disposed in a line direction and a plurality of data lines DL disposed in a row direction; a selection driver (selection driving section) 220 which is connected to the selection lines SL of the display panel 210 and sequentially applies a selection signal Ssel to respective selection lines SL at a predetermined timing; a power supply driver 230 which is connected to the power supply lines VL disposed in the line direction in parallel with the selection lines SL, and sequentially applies a supply voltage Vsc of predetermined voltage levels (Vscl, Vsch) to the power supply lines VL in synchronization with the selection signals Ssel; a data driver (data driving section) 240 which has the circuit configuration (see FIGS. 1 and 11) equivalent to the display driving device 100A or 100B described in the embodiments and performs a series of control operations (first embodiment) composed of the electric current setting operation, the voltage detecting operation and the pixel data-writing operation or a series of control operations (second embodiment) composed of the voltage setting operation, the electric current setting operation, the voltage detecting operation and the pixel data-writing operation on the display pixels PX in the respective rows connected to the data lines DL of the display panel 210; a system controller (driving control section) 250 which has a means for generating and outputting a selection control signal, a power supply control signal and a data control signal (timing control signal) for controlling operating states of the selection driver 220, the power supply driver 230 and the data driver 240 based on a timing signal supplied from a display signal generating circuit 260, described later; and a display signal generating circuit 260 which generates display data (luminance gradation data) composed of a digital signal and supplies the display data to the data driver 240 based on a video signal supplied from the outside of the display device 200, and generates a timing signal (system clock or the like) for displaying predetermined image information on the display panel 210 and supplies the timing signal to the system controller 250 based on the display data.

The data driver 240 has at least the gradation signal generating section 110, a voltage detecting section 160, the voltage adding section 130 and the constant current circuit section 140 shown in FIG. 1 similarly to the display driving device 100 or 100B (in the case where it is similar to the display driving device 100B shown in FIG. 12, it further includes the constant voltage circuit section 150).

FIGS. 1 and 12 illustrate the constitution corresponding to the single display pixel PX, but in the data driver 240 applied to the display device 200 of the present invention, the changeover switches SW1 and SW2 (or SW3) provided to each data line DL arranged in a row direction of the display panel 210 are controlled to be switched based on the described driving method, so that any one of the operation for supplying the constant current Iref (electric current setting operation) and the operation for applying the pixel data voltage (pixel data-writing operation) (further, the operation for applying the constant voltage Vini (voltage setting operation)), or the operation for loading the detected voltage Vdec (voltage detecting operation) is selectively executed on the data lines DL, (display pixels PX) in respective rows simultaneously in parallel (collectively) or each row.

The display driving devices 100A and 100B shown in FIGS. 1 and 12 have the constant current circuit section 140 and the constant voltage circuit section 150 for each display pixel PX in each row. However, the data driver 240 applied to the display device 200 of the present invention has the single constant current circuit section 140 and the constant voltage circuit section 150 for the data lines DL in all the rows or an arbitrary plurality of data lines DL, and an output current and an output voltage from the constant current circuit section 140 and the constant voltage circuit section 150 are branched for the respective data lines DL in the rows, so that the constant current Iref and the constant voltage Vini may be generated.

The display device 200 shown in FIG. 20 is provided with the selection driver 220 connected to the selection lines SL and the power supply driver 230 connected to the power supply lines VL separately around the display panel 210. However, as described in the driving method (see FIGS. 4 and 13), the selection signal Ssel applied to the selection lines SL (from the selection driver 220) on the display pixels PX on a specified line and the supply voltage Vsc applied to the power supply lines VL (from the power supply driver 230) are set so as to establish a relationship in which their signal levels are inverted. For this reason, when the display driving operation is performed on the display pixels PX arranged on the display panel 210 per line, the signal level of the selection signal Ssel generated by the selection driver 220 is inverted and is converted so as to have a predetermined voltage level (Vscl, Vsch), and is applied to the power supply lines VL in the corresponding lines. As a result, the power supply driver 230 can be eliminated so that the selection driver is used also as the power supply driver.

Therefore, when the above driving method is applied to the display device having such a constitution, prior to the operation for writing display data into the display pixels (driving circuits) and the operation for allowing the light emitting element (organic EL, element) to emit light, the voltage component corresponding to the threshold voltage of the driving transistor provided to each display pixel is always or occasionally detected and retained, and the pixel data voltage obtained by adding the gradation voltage corresponding to the display data to the voltage component corresponding to the threshold voltage of each display pixel (driving transistor) at the time of the detection is generated at the time of the display data-writing operation so as to be written into each display pixel. For this reason, even when the threshold voltage fluctuates (threshold shift) or disperses, the fluctuation or dispersion is compensated in real time, and the driving current having a value corresponding to the display data is supplied to the light emitting element (organic EL element), so that the light emitting operation can be performed with desired luminance gradation and the stable light emitting property can be realized for a long time.

In the display device and the driving method for the displays device according to the present invention, the display driving device (data driver) has a function for supplying a constant current to each data line of the display panel and detecting voltages of the data lines at the time of supplying the constant current to the driving circuits on the display pixels via the data lines. Since the detected voltage accords with the fluctuation in the threshold of the driving element in the driving circuit, a gradation voltage corresponding to the display data is corrected based on the detected voltage so that the fluctuation in the threshold of the driving element is compensated, and a driving current having a value corresponding to the display data is supplied to the light emitting element (organic EL element) so that light can be emitted with suitable luminance gradation. As a result, as the driving transistor to be provided to each display pixel, an amorphous silicon thin film transistor can be satisfactorily adopted.

What is claimed is:

1. A display device which displays image information corresponding to display data, comprising:
a display panel where a plurality of display pixels, each having a current-controlled light emitting element and a driving circuit for supplying a driving current to the light emitting element are arranged at intersecting points between a plurality of selection lines and data lines disposed in a column direction and a row direction, respectively;
a selection driving section which applies a selection signal to the display pixels on the lines on the display panel so as to set the display pixels into a selected state; and
a data driving section which generates a gradation signal corresponding to the display data so as to apply the gradation signal to the display pixels on the selection lines set into the selected state,
wherein the data driving section includes at least:
a constant current supplying section which supplies a constant current to the data lines; and
a voltage detecting section which detects voltages of the data lines at the time when the constant current is supplied to the driving circuits of the display pixels set into the selected state via the data lines.

2. The display device according to claim 1, wherein the data driving section further includes a gradation signal generating section which corrects a gradation voltage having a value corresponding to the display data based on the voltages of the data lines detected by the voltage detecting section so as to generate the gradation signal.

3. The display device according to claim 2, wherein the driving circuits have a driving element which includes a control terminal and an electric current path to which an electric current corresponding to a voltage value of the control terminal is applied and whose one terminal is electrically connected to the data lines and the light emitting elements so that the driving current is supplied to the light emitting elements,
the data driving section further includes a gradation voltage generating section which generates a gradation voltage having a value corresponding to the display data, and
the gradation signal generating section generates a pixel data voltage based on the voltages of the data lines detected by the voltage detecting section, the gradation voltage generated by the gradation voltage generation section and voltages intrinsic to the driving elements of the display pixels so as to apply the pixel data voltage as the gradation signals to the display pixels via the data lines, respectively.

4. The display device according to claim 3, wherein the voltages intrinsic to the driving elements are voltages between both ends of the electric current paths when the threshold voltages of the driving elements are 0V and the constant currents are applied to the electric current paths of the driving elements.

5. The display device according to claim 1, wherein the driving circuits have a driving element which includes a control terminal and an electric current path to which an electric current corresponding to a voltage of the control terminal is applied and whose one end is electrically connected to the data lines and the light emitting elements so that the driving currents are supplied to the light emitting elements, and
the voltages of the data lines detected by the voltage detecting section have a value corresponding to the voltages of the control terminals at the time when the constant currents is applied to the electric current paths of the driving elements via the data lines.

6. The display device according to claim 5, wherein the driving elements are electric field effect type thin film transistors, the electric current paths are formed between source and drain terminals of the thin film transistors, the control terminals are gate terminals, and the source terminals are electrically connected to the data lines and to one ends of the light emitting elements.

7. The display device according to claim 1, wherein an operation for supplying the constant current to the data lines by means of the constant current supplying section so as to detect the voltages of the data lines by means of the voltage detecting section is performed prior to an operation for applying the gradation signal to the display pixels by means of the selection driving section and the data driving section so as to allow the light emitting elements provided to the display pixels to emit light with a luminance gradation corresponding to the display data.

8. the display device according to claim 1, wherein the driving circuit has a control terminal and an electric current path to which an electric current corresponding to a voltage of the control terminal is applied and whose one end is electrically connected to the data line and the light emitting element so that the driving current is supplied to the light emitting element, and
the constant current is set to a value to a voltage value such that the voltage of the control terminal becomes higher than the threshold voltage of the driving element when the constant current is applied to the electric current path of the driving element.

9. The display device according to claim 8, wherein the constant current is set to a value such that the voltage of the control terminal becomes higher than a voltage obtained by adding the threshold voltage of the driving element and the gradation voltage corresponding to the display data when the constant current is applied to the electric current path of the driving element.

10. The display device according to claim 1, wherein the voltage detecting section has a voltage retaining section which temporarily retains voltage components corresponding to the voltages of the data lines.

11. The display device according to claim 1, wherein the voltage detecting section has a memory section which stores detected data corresponding to the detected voltages of the data lines individually according to each corresponding display pixel.

12. The display device according to claim 1, wherein the driving circuit has a driving element which has a control terminal and an electric current path to which an electric current corresponding to a voltage of the control terminal is applied and whose one end is electrically connected to the data line and the light emitting element so that the driving current is supplied to the light emitting element, and
the voltage detecting section has a memory section which stores the detected voltages of the data lines and threshold data generated based on voltages intrinsic to the corresponding driving elements on the display pixels individually according to corresponding respective display pixels.

13. The display device according to claim 12, wherein the voltage intrinsic to the driving element is a voltage between both terminals of the electric current path at the time when the threshold voltage of the driving element is 0V and the constant current is applied to the electric current path of the driving element.

14. The display device according to claim 1, wherein the data driving section has a constant voltage supplying section which applies a constant current to the data lines, and
an operation for applying the constant voltage to the data lines by means of the constant voltage supplying section is performed prior to an operation for supplying the constant current to the data lines by means of the electric current supplying section.

15. The display device according to claim 14, wherein the constant voltage applied by the constant voltage supplying section is set to a value which is higher than the voltages of the data lines at the time when the constant current is supplied to the data lines by the constant current supplying section.

16. The display device according to claim 1, wherein the driving circuit includes at least:
a first switch section whose contact with the light emitting element is connected to one end of an electric current path so that a predetermined supply voltage is applied to the other end of the electric current path;
a second switch section where the selection signal is applied to a control terminal, the supply voltage is applied to one end of the electric current path, and the control terminal of the first switch section is connected to the other end of the electric current path; and
a third switch section where the selection signal is applied to a control terminal, the data line is connected to one end of the electric current path and the connection contact point is connected to the other end of the electric current path,
the driving element is the first switch section, and
the voltage detecting section detects a voltage corresponding to an electric potential of the connection contact point of the first switch section.

17. The display device according to claim 1, wherein the light emitting element is an organic electroluminescence element.

18. A driving method for controlling a display device so that image information corresponding to display data is displayed, the display device including a display panel, where a plurality of display pixels, each having a current-controlled light emitting element and a driving circuit for supplying a driving current to the light emitting element are arranged at intersecting points between a plurality of selection lines and data lines disposed in a column direction and a row direction, respectively, and a constitution such that a selection signal is sequentially applied to the display pixels in respective selection lines on the display panel so that the display pixels are set into a selected state, and a gradation signal corresponding to display data for displaying desired image information is applied to the display pixels in the rows set into the selected state in synchronization with the selection timing so that the display pixels are allowed to emit light with predetermined luminance gradation and the desired image information is displayed on the display panel, the driving method comprising at least:
an operation for supplying a constant current to the data lines prior to an operation for applying the gradation signal to the display pixels; and
an operation for detecting voltages of the data lines at the time when the constant current is supplied to the display pixels set into the selected state via the data lines.

19. The driving method according to claim 18, wherein the driving circuit has a control terminal and an electric current path to which an electric current corresponding to a voltage of the control terminal is applied and whose one end is electrically connected to the data line and the light emitting element so that the driving current is supplied to the light emitting element, and
the driving method further comprises an operation for generating a pixel data voltage based on the detected voltages of the data lines, a gradation voltage generated according to the display data and voltages intrinsic to the driving elements on the display pixels so as to apply the pixel data voltage as the gradation signal to the display pixels via the data line.

20. The driving method according to claim 19, wherein the voltages intrinsic to the driving elements are a voltage between both ends of the electric current path at the time when threshold voltages of the driving elements are 0V and the constant current is applied to the electric currents of the driving elements.

21. The driving method according to claim 18, wherein the constant current is set to a value such that the voltage of the control terminal becomes higher than threshold voltages of the driving elements when the constant current is applied to the electric current paths of the driving elements.

22. The driving method according to claim 21, wherein the constant current is set to a value such that the voltage of the control terminal becomes higher than a voltage obtained by adding the threshold voltage of the driving element and the gradation voltage corresponding to the display data when the constant current is applied to the electric current paths of the driving elements.

23. The driving method according to claim 18, further comprising an operation for applying a constant current to the data lines prior to the operation for supplying the constant current to the data lines.

24. The driving method according to claim 23, wherein the constant voltage is set to a value higher than the voltages of the data lines at the time when the constant current is supplied to the data lines.

25. The driving method according to claim 18, wherein the operation for detecting the voltages of the data lines at the time of supplying the constant current to the display pixels set into the selected state via the data lines is performed in every display driving period at which the display pixels emit light with a luminance gradation corresponding to the display data.

26. The driving method according to claim 18, wherein the operation for detecting the voltages of the data lines at the time of supplying the constant current to the display pixels set into the selected state via the data lines is performed intermittently in an arbitrary processing cycle period in the case where a display driving period for allowing the display pixels to emit light with a luminance gradation corresponding to the display data is determined as one processing cycle period.
